(19) United States
(12) Patent Application Publication
(10) Pub. No.: US 2013/0138648 A1
(43) Pub. Date: May 30, 2013

(54) SYSTEM AND METHOD FOR MANAGING REVIEW STANDARDS IN DIGITAL DOCUMENTS

(71) Applicant: Jason Michael Kaufman, Renton, WA (US)

(72) Inventor: Jason Michael Kaufman, Renton, WA (US)

(21) Appl. No.: 13/752,328

(22) Filed: Jan. 28, 2013

Related U.S. Application Data
(63) Continuation of application No. 11/379,768, filed on Apr. 21, 2006, now abandoned.
(60) Provisional application No. 60/683,741, filed on May 23, 2005.

(51) Int. Cl. G06F 17/30

(52) U.S. Cl. CPC G06F 17/30011
USPC 707/736

(57) ABSTRACT

A system and method for validation, review, approval, editing, developing, publishing, and/or ongoing maintenance of a digital document, the system and method having the functionality to work alone or can be used in conjunction with other software applications and workflows in order to facilitate the direct review of documents.

### PRIORITY CLAIM

This application is a continuation of U.S. patent application Ser. No. 11/379,768 filed on Apr. 21, 2006 which claims priority to U.S. Provisional Application No. 60/683,741 filed on May 23, 2005. Each of the foregoing applications are herein incorporated by reference in their entirety.

### BACKGROUND OF THE PREFERRED EMBODIMENT

The software used to create content documents in digital environments has experienced tremendous investment since the inception and proliferation of the computer. Reviewing and revising digital documents is very problematic, because numerous intra-institutional entities have a small but important investment in the outcome. Currently, the review of digital documents requires the writer to print, hand deliver, fax, or e-mail, a hard or soft copy to those responsible for review, editing, and/or approving the document for publication. That approving entity may then make the changes and then print, hand deliver, fax, or e-mail, a hard or soft copy to the next person responsible for review, editing, and/or approving the document. In the midst of multi-platform environments and the users that drive them, the process may require tremendous effort on the part of the writer to champion the document through an often unclear path to completion.

Additionally, the current approaches fail to consistently capture invaluable review data which may enable management to recognize key trends and bottlenecks/barriers to a fast and efficient review process for such documents. The specific trends are difficult, if not impossible, to assess within the current document review environment as written works are often emailed, faxed, copied, and/or filed in multiple disparate physical and electronic locations. These current approaches are time consuming and cumbersome, and as such, many companies simply elect to forgo stages of review to cut costs and time, thereby resulting in a lower quality of review and continuously high costs. Therefore there is a need for system and method for managing review standards in digital documents.

### SUMMARY OF THE INVENTION

A system and method for validation, review, approval, editing, developing, publishing, and/or ongoing maintenance of a digital document, the system and method having the functionality to work alone or to be used in conjunction with other software applications and workflows in order to facilitate the direct review of documents.

### BRIEF DESCRIPTION OF THE DRAWINGS

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a screenshot of a login page;

FIG. 4 is a screenshot of a My Worklist screen;

FIG. 5 is a screenshot of a My Requests page;

FIG. 6 is a screenshot of an Edit Filter page;

FIG. 7 is a screenshot of an Assign Tasks page;

FIG. 8 is a screenshot of the Hide Top Navigation function;

FIG. 9 is a screenshot of the Content Manager page;

FIG. 10 is a screenshot of the Content Evaluation page;

FIG. 11 is a screenshot of the Content Evaluation page with the checklist not yet selected;

FIG. 12 is a screenshot of a Select Checklist page;

FIG. 13 is a screenshot of a Content Evaluation page with the checklist shown;

FIG. 14 is a screenshot of a Content Evaluation page with the Checklist Hidden;

FIG. 15 is a screenshot of a Content Request page;

FIG. 16 is a screenshot of a Direct Request page;

FIG. 17 is a screenshot of a Tool Administration page;

FIG. 18 is a screenshot of a Manage Users page;

FIG. 19 is a screenshot of an Edit Users page;

FIG. 20 is a screenshot of a Manage Checklists page;

FIG. 21 is a screenshot of an Edit Checklists page;

FIG. 22 is a screenshot of a Manage Projects page;

FIG. 23 is a screenshot of an Edit Project page;

FIG. 24 is a screenshot of a Manage Checklists page;

FIG. 25 is a screenshot of a Manage Resources page;

FIG. 26 is a screenshot of a Download Data page;

FIG. 27 is a screenshot of a Support Site Knowledge Base;

FIG. 28 is a screenshot of a Support Site FAQ's page;

FIG. 29 is a screenshot of an Average Review Scores report;

FIG. 30 is a screenshot of an Average Review Scores by Reviewer report;

FIG. 31 is a screenshot of an Overall Average Review Time report;

FIG. 32 is a screenshot of an Average Review Time by Reviewer Trend report;

FIG. 33 is a screenshot of a Checklist Findings Distribution report;

FIG. 34 is a screenshot of a Review Count by Reviewer report;

FIG. 35 is a screenshot of a Total Reviews Report;

FIG. 36 represents a method for executing a preferred embodiment;

FIG. 37 represents a method for content change request workflow;

FIG. 38 represents a method for content review/evaluation workflow;

FIG. 39 represents a method for submitting a new content creation request;

FIG. 40 represents a method for evaluating content outside of workflow (direct evaluation);

FIG. 41 represents a method for evaluating content housed in another system step; and

FIG. 42 represents a method for reviewing project administration.

### DETAILED DESCRIPTION OF THE PREFERRED EMBODIMENT

An embodiment provides an interface through which document reviewers and approvers may use system generated checklists to capture review results. An embodiment tracks the date, time, review duration, reviewer, reviewee, checklist version, and/or the findings for one or more, or each, individual checklist item. In alternate embodiments other tracking categories are available. The review results then are recorded in a relational database upon completion. The review result information may be extracted from the database for analysis on calibration of review standards and methodologies between reviewers, as well as the average time the reviewer is taking to perform the review task. The data displays an average score by reviewee (writer) and the number of documents on which they were evaluated. An embodiment allows the reviewer the ability to communicate standards to the reviewee prior to the review of their documents. Once the standards, rules and expectations are set, the reviewer may begin sending documents back to the reviewee for correction before passing along to the next step in the process. Using this methodology, standards are continuously communicated back to the people responsible for upholding those standards. This practice results in greater communication between the various levels of reviewers and ultimately a more streamlined and efficient review process. In alternate embodiments fewer or more steps or alternate sequences are utilized.

An embodiment still includes the human element in review of written works, and it allows those involved in the review process to have accountability in their roles and responsibilities. A preferred embodiment accomplishes responsibility by forcing review stakeholders to clearly identify what standards they applied at any given point in the document review process, then holding them accountable for applying those standards consistently. By providing reports and analysis (and other acceptable performance tracking measures) of trends in the scoring of these review stakeholders, they are compelled to identify the precise areas of misunderstanding and further optimize or clarify their roles and responsibilities.

An embodiment picks up where collaboration tools leave off. Tools in today's business world are focused on the creation of the document, without regard for the critical processes that take place after the initial draft is complete or the steps before that document may be passed on to its intended audience. An embodiment includes a tool by which the review process may be enabled to operate as an assembly line. One or more, or each, step in the process may enable the next. Review stakeholders have the opportunity to pass the document back to the previous reviewer to have specific standards applied before it may continue through the review workflow. This enables the immediate discussion to focus upon what standards should have been applied and were not. This fosters a review environment where mistakes are discussed right away and prevented from happening again in subsequent documents. In alternate embodiments fewer or more steps or alternate sequences are utilized.

Functionality is at the core of the improved productivity that may take place. Review stakeholders know exactly what they are held accountable for, given the opportunity to immediately correct any mistakes, and prevent the same mistake from being made and corrected on future documents of that type.

Once review roles and responsibilities are understood, the need to constantly give the document back to the author is obsolete if the document passes the review at any given stage. The author is no longer responsible for managing the review process; it is a combined effort of multiple stakeholders doing their part in the process to move the document along.

A method of using one embodiment includes: (1) Writer submits a document for peer review. (2) A peer reviewer reviews the document against peer review standards. (3) If the document meets review standards, the peer reviewer submits the document to the next level of review, a copy editor. If the document does not meet review standards, then the document is passed back to the writer to make corrections. (4) The copy editor reviews the document against the copy editing standards. (5) If document meets review standards, the editor submits the document to the next level of review, a publisher. Otherwise the document is passed back to the copy editor to make corrections. In alternate embodiments this process involves others within a company such as members of marketing, legal, public relations, executive, and technical experts. Adding these other layers to the review process for validation purposes enables the creation of a solid, properly balanced and positioned company message to the public. In alternate embodiments fewer or more steps or alternate sequences are utilized.

In accordance with other aspects of an embodiment, an embodiment may create a system-driven checklist whereby the system is prompted by algorithms which determine discrepancies between optimal production values (rates, quantity, and quality) and current metrics, and prompt the user to close the quantitative and qualitative gaps between these metrics. In alternate embodiments other algorithms may be used.

An embodiment is implemented on a computer, personal digital assistant, uploaded on a server, accessible via an intranet and/or the internet, and/or other digital means.

Further an embodiment produces a tangible list that displays the current state of documents in the editing pipeline.

An embodiment further includes a web based application which enables small to enterprise level companies to manage and report on their existing document/content review and approval processes.

An embodiment is a logical extension of a document creation process. Once a draft of a document is complete, its lifecycle is at its beginning The process for validation, review, approval, editing, developing, publishing and ongoing maintenance may then begin. Though an embodiment provides workflow functionality, the tool is used in conjunction with other office applications and workflows for the direct review of documentation. Where content workflow, content tracking, content management, and content collaboration tools focus on getting a document from person to person and status to status, an embodiment focuses on capturing what happens when the document reaches one or more, or preferably each, of a set of defined individuals. This is accomplished, in one embodiment, through the use of an electronic checklist through which users may select a pass, allowing a document to proceed to the next step, or findings, which allow a user to record why the document does or does not meet the defined standards. This process allows for misunderstandings and unclear guidelines to rise to the surface, thus allowing for continuously updated and communicated standards. In alternate embodiments other algorithms and/or combinations of algorithms are used.

In one embodiment there is an area on a graphical user interface entitled “My Worklist” which includes content tasks that are “Assigned to” a user regardless of “Status”. An operation may be accomplished by a single click on the task graphic to view the task summary/history, further a double-click may be used to open the workflow options for reassigning and changing status. In alternate embodiments other algorithms and/or combinations of algorithms are used.

In one embodiment there is an area in the graphical user interface entitled “My Requests” and may include content tasks that were “requested” (via the Content Request page) by a user.

In one embodiment there is an area in the graphical user interface entitled “Filter Options” which may provide fields through which data in the page may be filtered.

In one embodiment there is an area in the graphical user interface entitled “Enable Filter” which may toggle the filter on and off

In one embodiment there is an area in the graphical user interface entitled “Content Manager” which includes content tasks regardless of “Status” or “Assigned To” values. This page allows a user to view the entire picture of all document tasks. A single click on the “task” graphic may allow a user to view the task summary/history, a double-click may allow a user to open the workflow options for reassigning and changing status. In alternate embodiments any number of clicks may bring up any available screen.

In one embodiment there is an area in the graphical user interface entitled “Content Evaluation” which lists content tasks that have the “Ready for Review” value in the “Status” field. When the review icon is clicked, the document to be reviewed appears in the main window. The checklist frame appears at the right with the option to “Select Checklist.” When the “Select Checklist” link is clicked, the user is presented with a list of checklists for the “Review Projects” that they are assigned. Users, in one embodiment, do not see checklists for projects that they are not assigned to. The “electronic checklist” and its management are a part of an embodiment. Users evaluate documents based on the standards listed in the checklist and may enter “Pass” or “Findings” for one or more, or preferably each, checklist item. If “Findings” is selected the user may be presented with a “Findings” box in which the user enters the information requiring correction. When the checklist is complete, the user clicks the “Submit” button which writes the content review results to the database as well as writes the review information to the user's clipboard for easy transfer into another workflow application. In alternate embodiments other algorithms may be used. In alternate embodiments the user may select “N/A” if a specific checklist item does not apply to the document being reviewed.

In one embodiment, a timer is included in order to track the amount of time used for review of each document. While in the course of using the checklist, the user may click the “Pause” button to pause the timer if they need to step away from the review for any amount of time. Upon returning the user may press the “Pause” button once again to resume the timer, or they may click a “Pass” or “Findings” button to resume the checklist timer.

While in the course of using the checklist, the user may click the “Hide Checklist” button to utilize more of their screen area for their review. When needed the user may click the “Show Checklist” button to restore the checklist to its default size.

The user may also click the “Collapse Top” button at any time while working within the application to minimize the top menu and utilize even more of their screen area. The user may click the “Expand Top” button to restore the top menu to its default size.

While using the checklist the user may click the checklist details button to reference the detailed information associated with the checklist item.

In one embodiment there is an area in the graphical user interface entitled “Content Request”. Using the “Standard Workflow” users are presented with the ability to request changes to specific internal or external content/documents or request the creation of a new document. They are able to assign a task to another member of the Review Project team. Further, by using the “Direct Evaluation” option users are able to enter specific existing content/documents for immediate review against existing checklists relating to the specific “Content Project” that the user selects. In alternate embodiments the user may have the option to upload a document onto the application server.

In one embodiment there is an area in the graphical user interface entitled “Tool Admin” which includes an area for the creation and management of departments, users, checklists, review projects, and the download of data from the database tables.

In the “Manage Checklists” page the user is able to create a new checklist and add or remove individual checklist items. The user assigns checklist ownership to a specific department. The user may change the status of a checklist to active, archived, and/or inactive.

While creating and or editing the checklist the user may have the option to enter detailed descriptions of the checklist purpose and/or expand on the details about a specific checklist guideline.

In the “Manage Projects” page the user is able to create new and manage the status (Active, On Hold, or Complete) of existing review projects. The user manages which “Project Resources” (users) are assigned to a review project. The user may also determine which “Project Checklists” apply to the review project, thus allowing the users access to the appropriate review checklists.

In the “Download Data” page the user selects from multiple database fields to download values to their desktop. The user may also select to download standard review reports. Users may also draw workflow path relationships between members of review teams for specific document types.

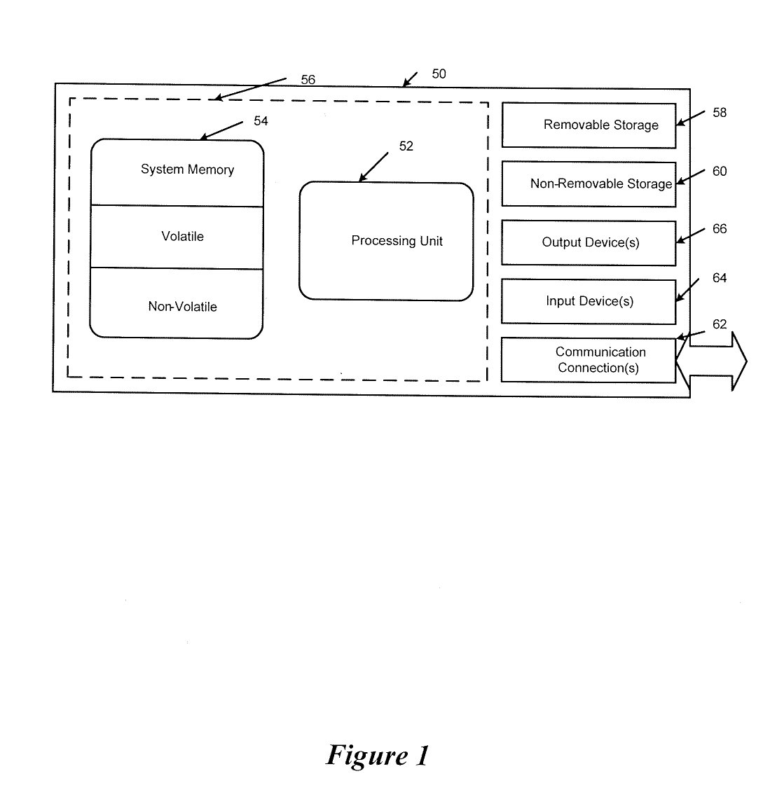

FIG. 1 illustrates an example of a suitable computing system environment 50 on which an embodiment of the invention may be implemented. The computing system environment 50 is only one example of a suitable computing environment and is not intended to suggest any limitation as to the scope of use or functionality of embodiments of the invention. Neither should the computing environment 50 be interpreted as having any dependency or requirement relating to any one or combination of components illustrated in the exemplary operating environment 50.

Embodiments of the invention are operational with numerous other general-purpose or special-purpose computing-system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed-computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed-computing environment, program modules may be located in both local- and remote-computer storage media including memory storage devices.

With reference to FIG. 1, an exemplary system for implementing an embodiment of the invention includes a computing device, such as computing device 50. In its most basic configuration, computing device 50 typically includes at least one processing unit 52 and memory 54.

Depending on the exact configuration and type of computing device, memory 54 may be volatile (such as random-access memory (RAM)), non-volatile (such as read-only memory (ROM), flash memory, etc.) or some combination of the two. This most basic configuration is illustrated in FIG. 1 by dashed line 56.

Additionally, device 50 may have additional features/functionality. For example, device 50 may also include additional storage (removable and/or non-removable) including, but not limited to, magnetic or optical disks or tape. Such additional storage is illustrated in FIG. 1 by removable storage 58 and non-removable storage 60. Computer storage media includes volatile and nonvolatile, removable and non-removable media implemented in any method or technology for storage of information such as computer-readable instructions, data structures, program modules or other data. Memory 54, removable storage 58 and non-removable storage 60 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 50 [Scott: careful with numbering here.]. Any such computer storage media may be part of device 60.

Device 60 may also contain communications connection(s) 62 that allow the device to communicate with other devices. Communications connection(s) 62 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF), infrared and other wireless media. The term computer-readable media as used herein includes both storage media and communication media.

Device 50 may also have input device(s) 64 such as keyboard, mouse, pen, voice-input device, touch-input device, etc. Output device(s) 66 such as a display, speakers, printer, etc. may also be included.

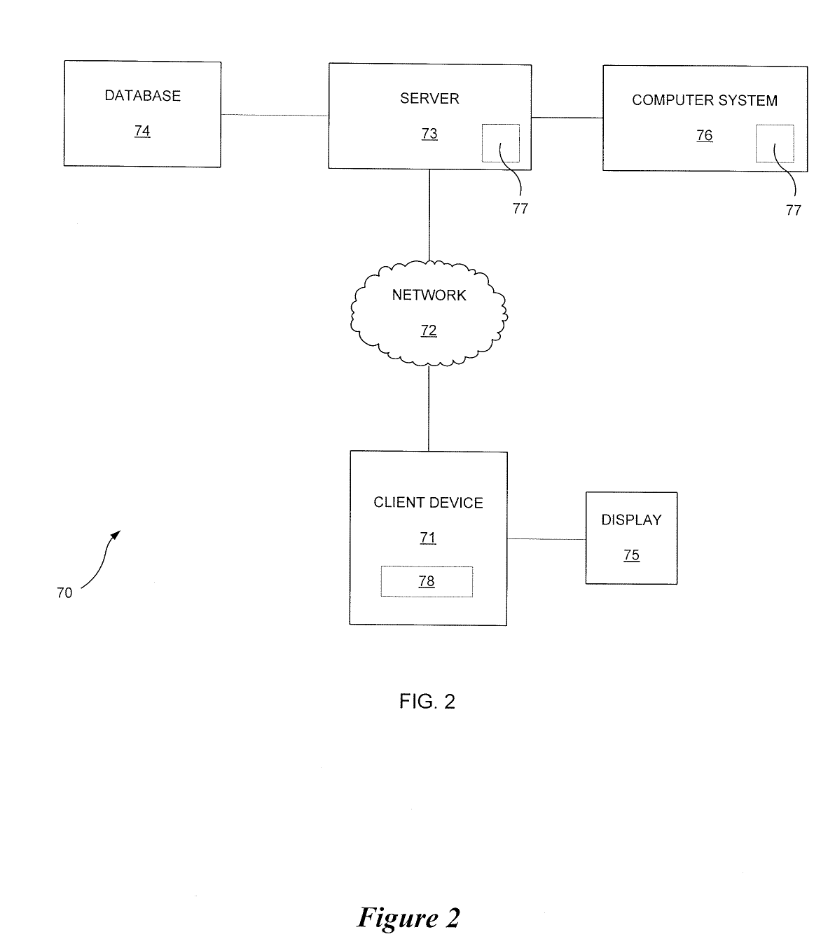

Referring now to FIG. 2, an embodiment of the present invention can be described in the context of an exemplary computer network system 70 as illustrated. System 70 includes an electronic client device 71, such as a personal computer or workstation, that is linked via a communication medium, such as a network 72 (e.g., the Internet), to an electronic device or system, such as a server 73. The server 73 may further be coupled, or otherwise have access, to a database 74 and a computer system 76. Although the embodiment illustrated in FIG. 2 includes one server 73 coupled to one client device 71 via the network 72, it should be recognized that embodiments of the invention may be implemented using one or more such client devices coupled to one or more such servers.

In an embodiment, each of the client device 71 and server 73 may include all or fewer than all of the features associated with the device 50 illustrated in and discussed with reference to FIG. 1. Client device 71 includes or is otherwise coupled to a computer screen or display 75. Client device 71 can be used for various purposes including both network- and local-computing processes.

The client device 71 is linked via the network 72 to server 73 so that computer programs, such as, for example, a browser, running on the client device 71 can cooperate in two-way communication with server 73. Server 73 may be coupled to database 74 to retrieve information therefrom and to store information thereto. Database 74 may include a plurality of different tables (not shown) that can be used by server 73 to enable performance of various aspects of embodiments of the invention. Additionally, the server 73 may be coupled to the computer system 76 in a manner allowing the server to delegate certain processing functions to the computer system.

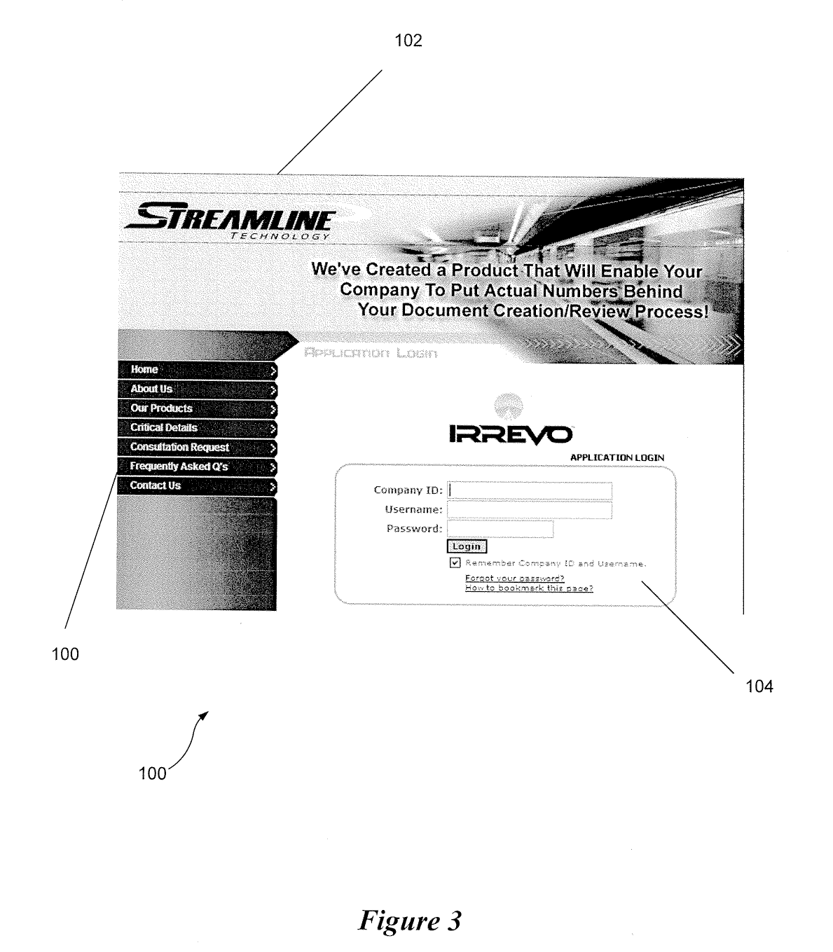

FIG. 3 is a screenshot of a login page, in one embodiment. The login page comprises a title bar 102, a menu 100, and a login box 104. In the login box 104 a user enters in login information, such as a Company ID, a Username, and/or a Password.

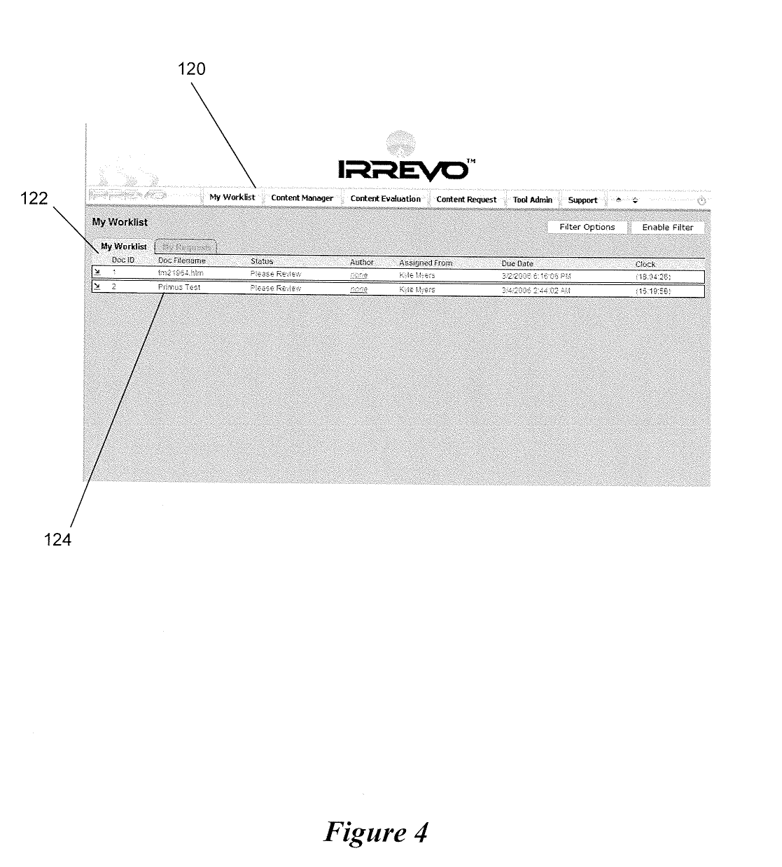

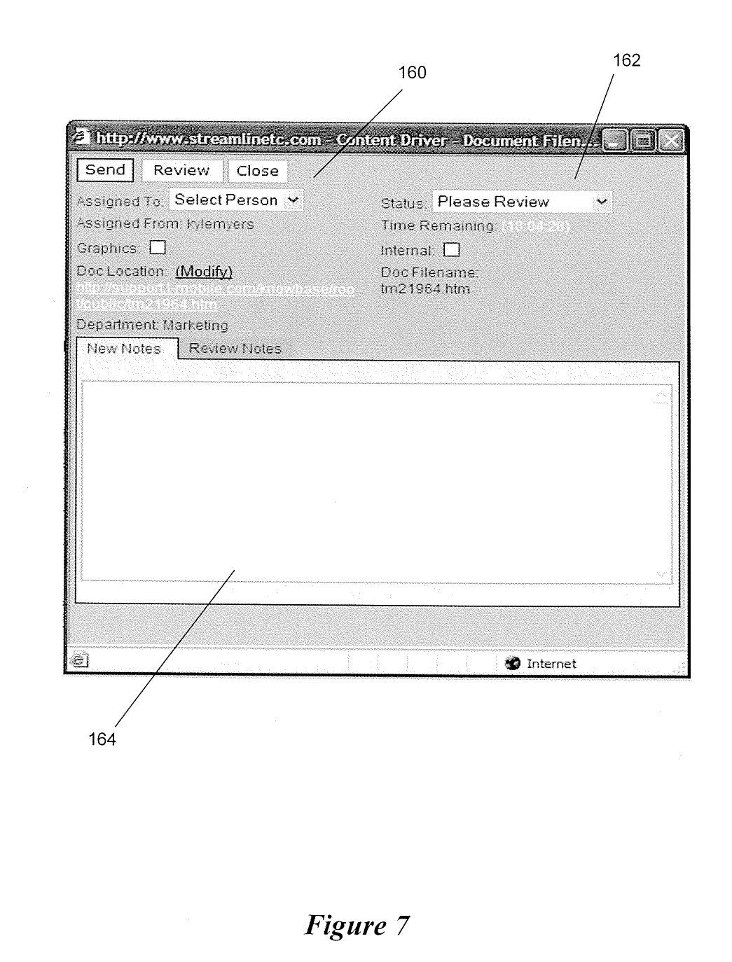

FIG. 4 is a screenshot of a My Worklist screen, in one embodiment. Once logged into the system a user is presented with their worklist 124 as the default view, with the “My Worklist” tab 122 selected. In this default view there are a series of menu options 120. The menu options 120 include in one embodiment, My Worklist, Content Manager, Content Evaluation, Tool Admin, and/or Support. A user's worklist 124 includes any review document in the system where their name is the value in the “Assigned to” field. Each document contains, at least one of a document ID, a Document Filename, Status, Author, Assigned From, due date, and/or a Clock. From this page users are given the functionality click once on the expand checklist icon to review history as well as the summary of the requested changes. If the user clicks twice they are presented with the “Assign Tasks” window (FIG. 7).

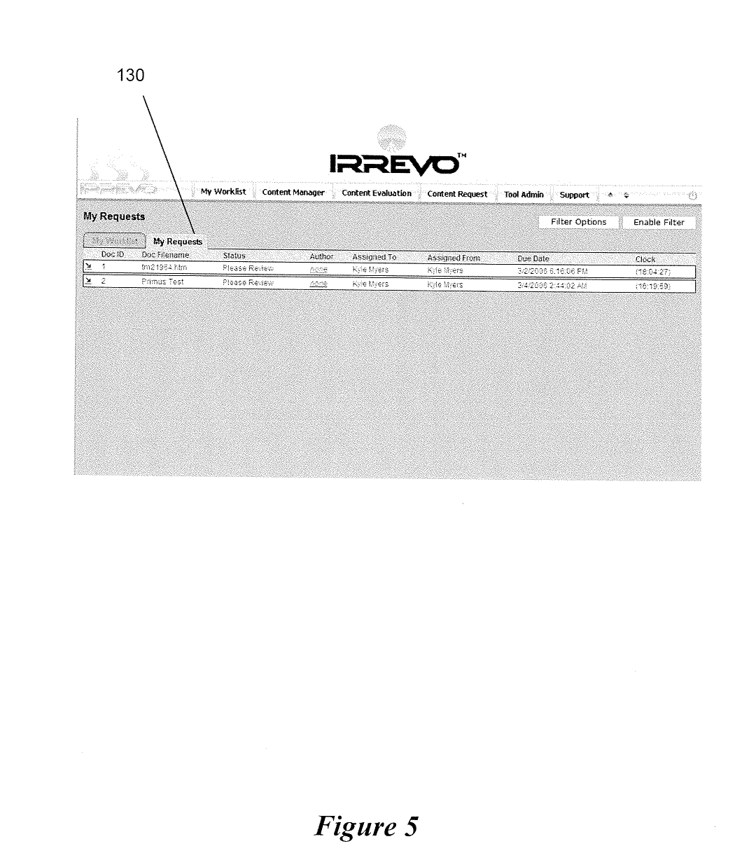

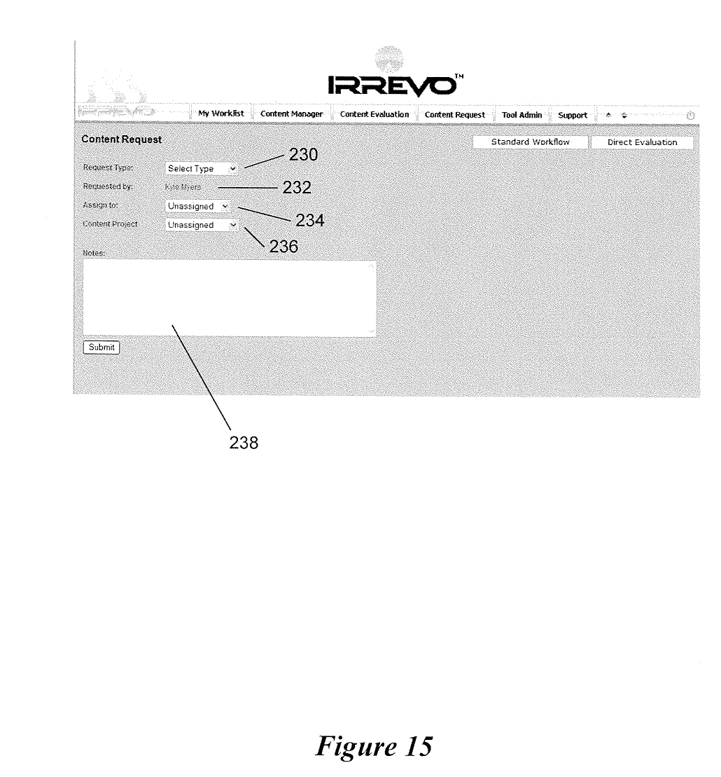

FIG. 5 is a screenshot of a My Requests page, in one embodiment. In this screenshot the my requests tab 130 is selected. Users can click the “My Requests” tab 130 from the “My Worklist” (FIG. 4) page to view the review history, the review status and who the review is assigned to. Users can see all requests that they originated via the “Content Request” (FIG. 15) page.

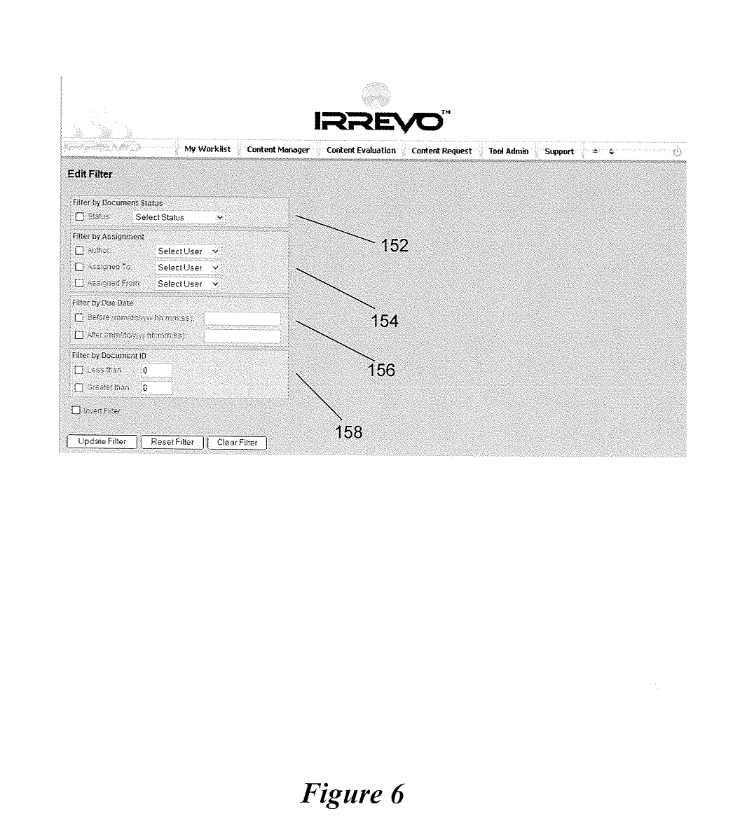

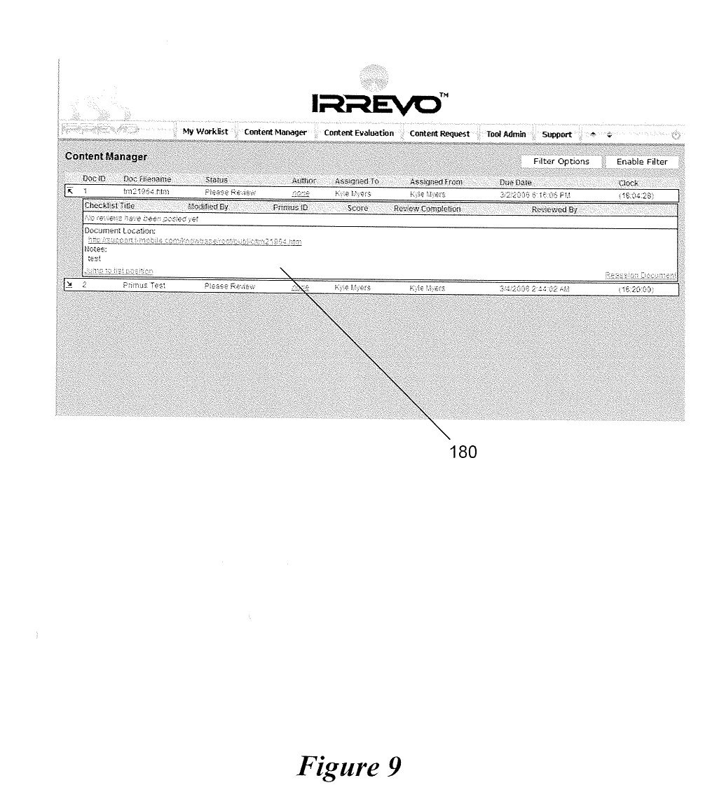

FIG. 6 is a screenshot of an Edit Filter page, in one embodiment. While users are in either the “My Requests” page or the “Content Manager” (FIG. 9) page they have the ability to access the “Edit Filter” page. From this page the user can select which values they would like to display on the “My Requests” or “Content Manager” pages to limit their search/view to a certain set of information. In box 152, a user may elect to filter by document status. In box 154, a user may filter by assignment; the assignment is characterized as either the author, the user the document is assigned to, and/or the user the document was assigned from. In box 156, a user may filter by Due Date. Finally in box 158, a user may filter by document ID.

FIG. 7 is a screenshot of an Assign Tasks page, in one embodiment. Once the user has performed their review, the user can use the “Assign Tasks” functionality to select the name, in the assigned to drop down box 160, of the next user who will perform a task on the document. The user may also select, in the dropdown box 162, what status they would like to appear when the originating user accesses their “My Worklist” page. Users can also modify the location information for the file being reviewed. Users may also choose to indicate whether a document contains “Graphics” or is intended for “Internal” use/distribution. Users may also enter in additional comments, in text box 164, for the historical record and/or to communicate any special considerations to the next user in the process.

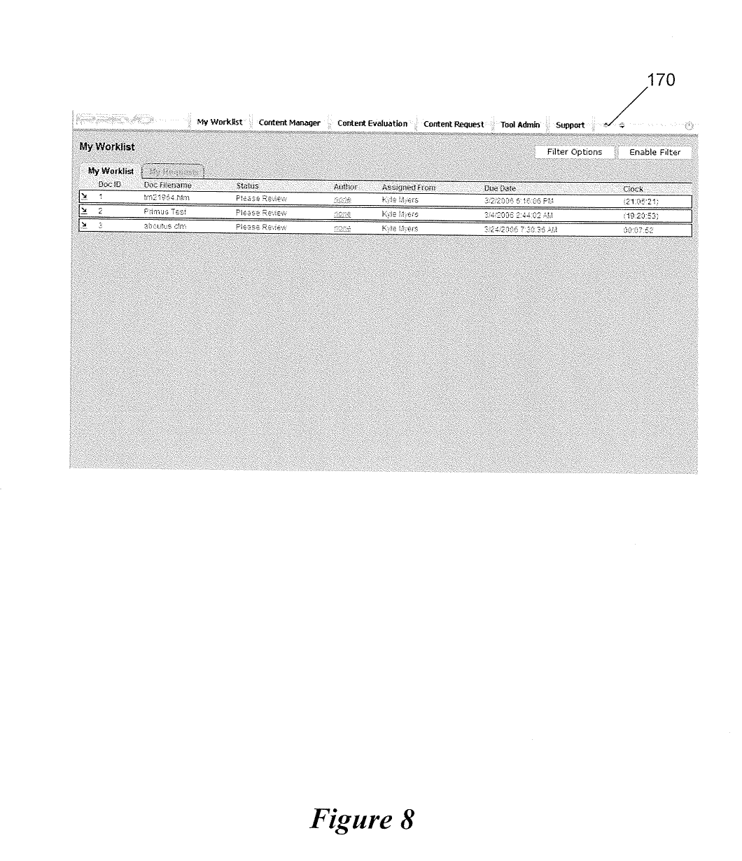

FIG. 8 is a screenshot of the Hide Top Navigation function, in one embodiment. Users may elect to minimize the size of the “Top Navigation” to allow for more area on the screen to view the content in the main window. In one embodiment a user minimizes the “Top Navigation” by clicking on an arrow graphic 170. This functionality is available for use regardless of what page the user is in within the application.

FIG. 9 is a screenshot of the Content Manager page, in one embodiment. The “Content Manager” page allows users to view all tasks, in box 180, within the application regardless of who they are assigned to. Otherwise this page preferably, but not necessarily has similar functionality to the “My Worklist” page.

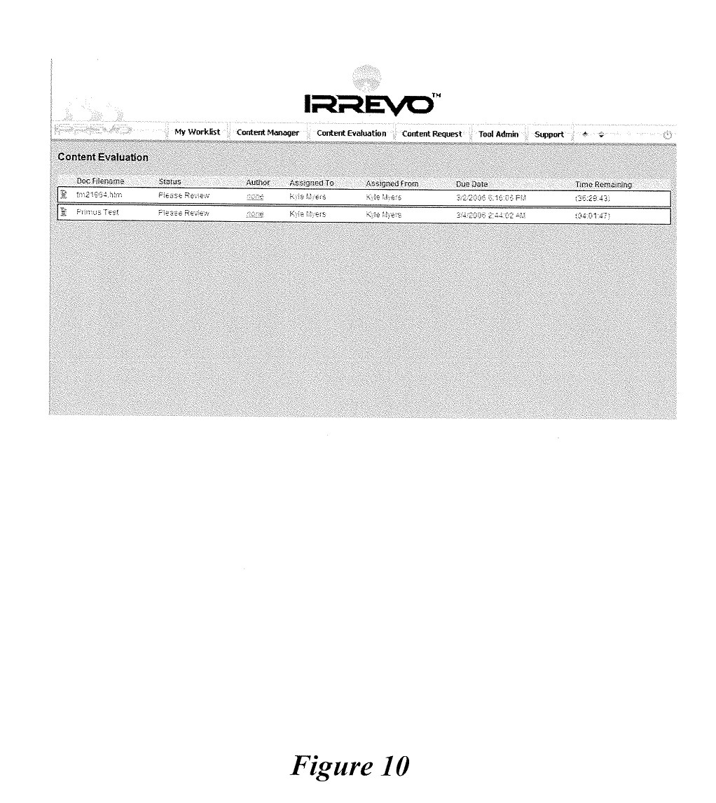

FIG. 10 is a screenshot of the Content Evaluation page, in one embodiment. The “Content Evaluation” page allows for users to select which document they would like to evaluate. It further allows a user to view the review standards related to the digital media being evaluated.

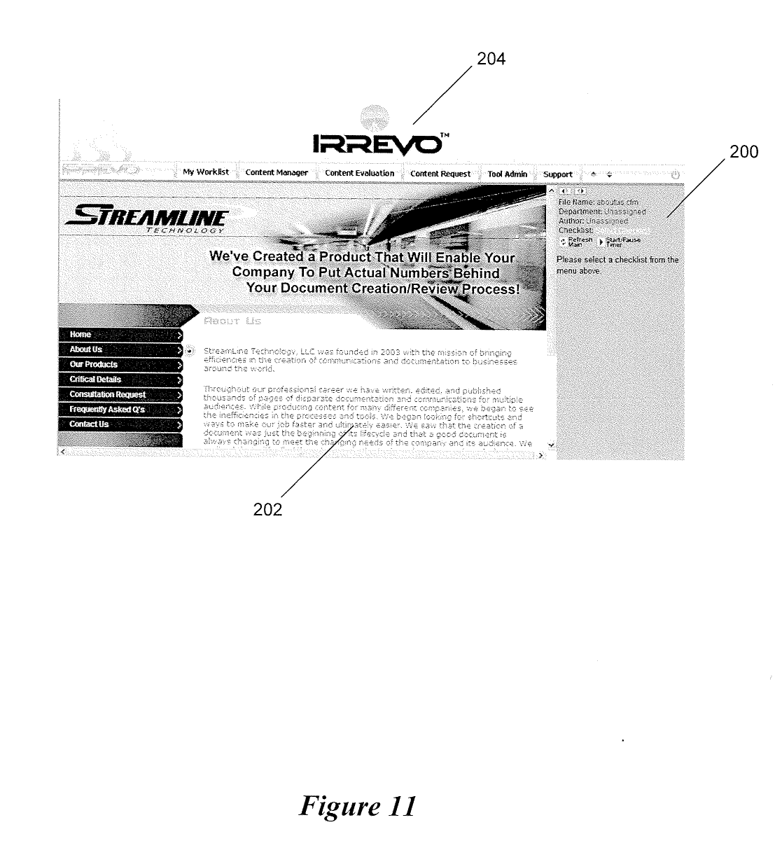

FIG. 11 is a screenshot of the Content Evaluation page with the checklist not yet selected, in one embodiment. This page prompts users to “Select a Checklist” from the checklists available on the “Select Checklist” (FIG. 10) page. As is represented in FIG. 9, the screen is split into three sections, the document to review 202, the select checklist area 200, and the program title and navigation bar 204.

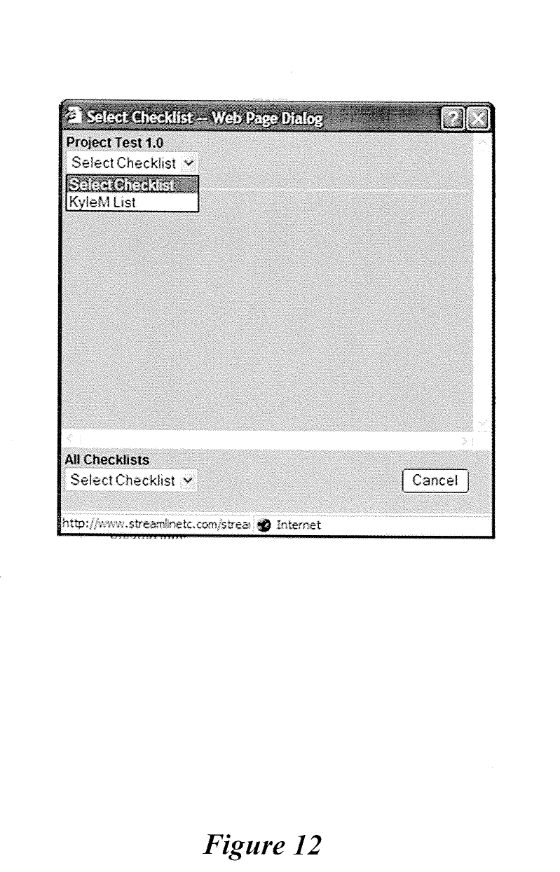

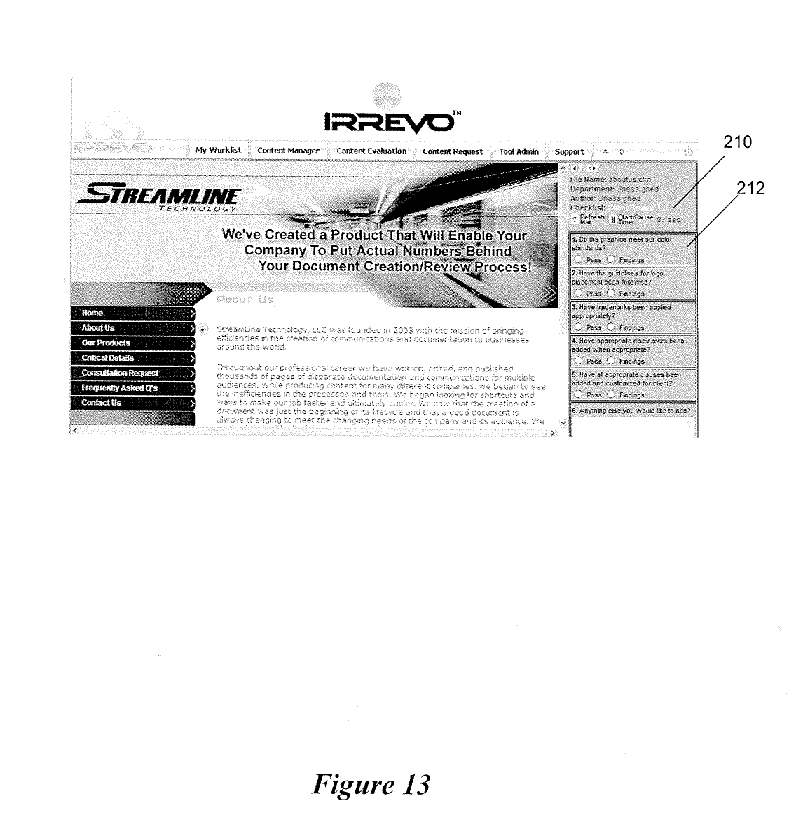

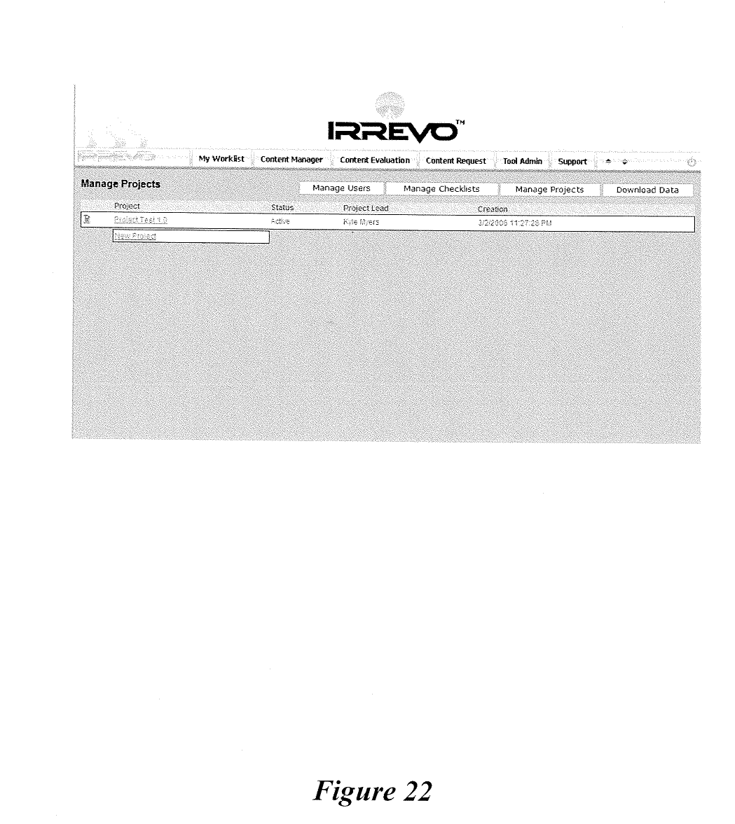

FIG. 12 is a screenshot of a Select Checklist page, in one embodiment. This screen is generated after a user has clicked “Select Checklist” which is shown in FIG. 11, reference numeral 200. On this page users are able to view the checklists for Review Projects that they have been associated with via the “Manage Projects” (FIG. 22) functionality. Once a checklist has been selected it is shown in FIG. 13 at reference numeral 212.

FIG. 13 is a screenshot of a Content Evaluation page with the checklist shown, in one embodiment. Once a checklist is selected a user can be presented with the checklist adjacent to the digital media being reviewed. Although the “Checklist Timer” automatically begins once a checklist has been selected, users have the ability to pause and resume the checklist timer. If paused, the timer can automatically begin again once any checklist value is changed. A user also has the option to “Refresh” the page being evaluated. Users evaluate the digital media against each standard on the checklist to ensure the standards are being met. Based on this evaluation the user selects “Pass” or “Findings”. If “Findings” is selected the user is presented with a text box in which they can enter their comments. In alternate embodiments, the user may select “N/A” if a specific checklist item does not apply to the document being reviewed. Once the checklist is complete the user then clicks “Submit,” at which point the review results are recorded in a database as well as to the user's clipboard for pasting into potential other applications or notes. In this example, the checklist 210 selected is OnlineReview 1.0 and an example of a review standard is shown in box 212.

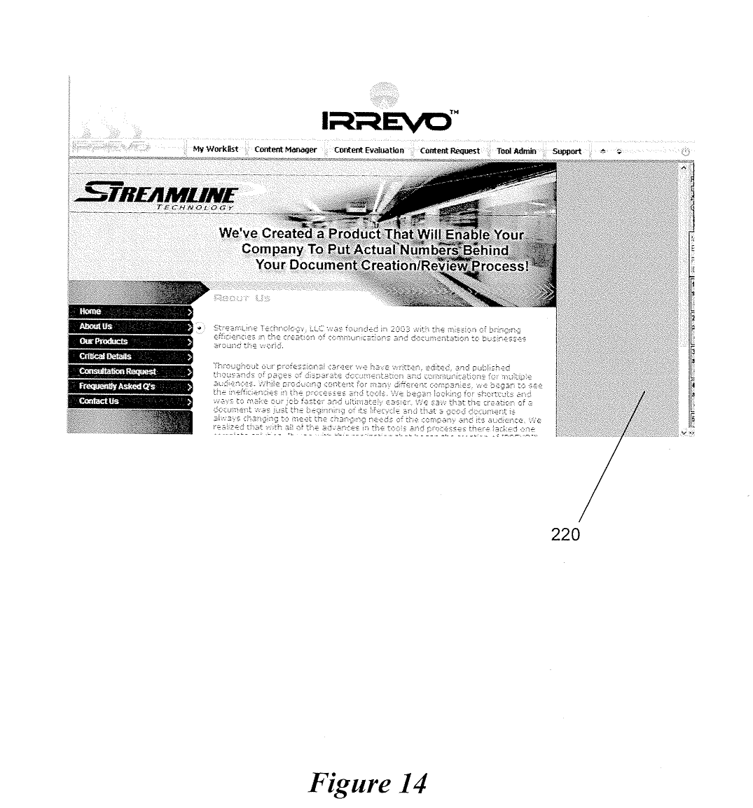

FIG. 14 is a screenshot of a Content Evaluation page with the Checklist Hidden, as demonstrated by the empty space 220. Users have the ability to click to hide the checklist in order to display more of the evaluation screen. Also, users may click the same icon to restore the checklist to its full size.

FIG. 15 is a screenshot of a Content Request page, in one embodiment. From this page users have the ability to enter evaluation requests into the system. The user further has reviewing functionality. A user can paste the file path and document name information into the appropriate fields. In an alternate embodiment a user may upload the entire file to be reviewed. They then select the “Request Type,” shown in drop down box 230, to alert the assignee of what type of change they are requesting. Next, the user selects an assignee from the “Assign To” drop down box 232 as well as a “Content Project” from drop down box 236 that the document type is associated with. Finally, a text box 238 is provided for notes.

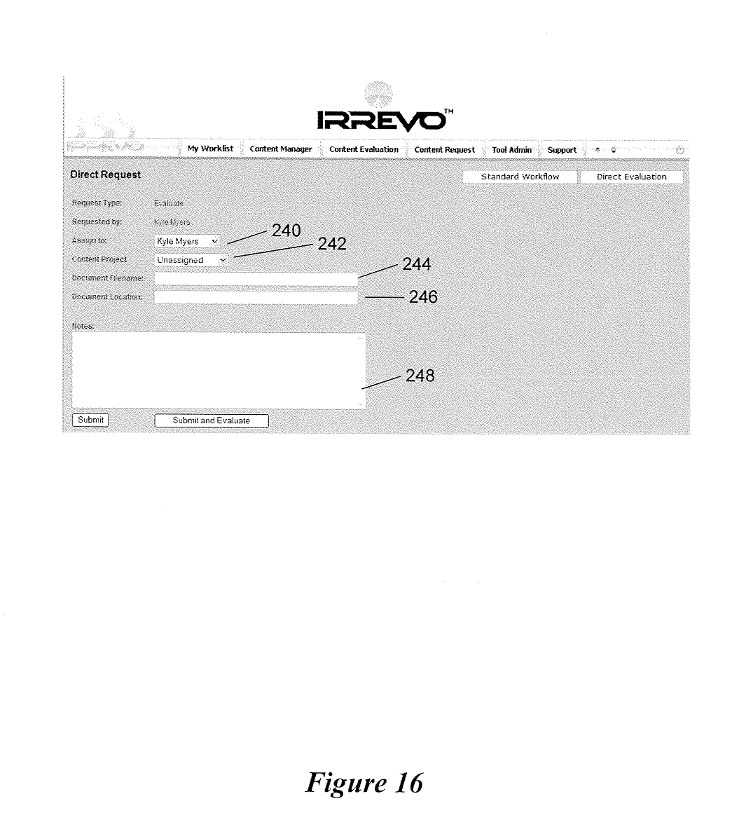

FIG. 16 is a screenshot of a Direct Request page, in one embodiment. Users may elect to enter a document into the application for immediate review via checklist. The user selects an assignee from the “Assign To” drop down box 240 as well as a “Content Project” from drop down box 242 that the document type is associated with. The user then enters the document file name into text box 244 and the document location into textbox 246. A user may enter notes into text box 248. Once the file path and document name information is entered the user may click “Submit and Evaluate” to be taken directly to the “Select Checklist” (FIG. 12) page.

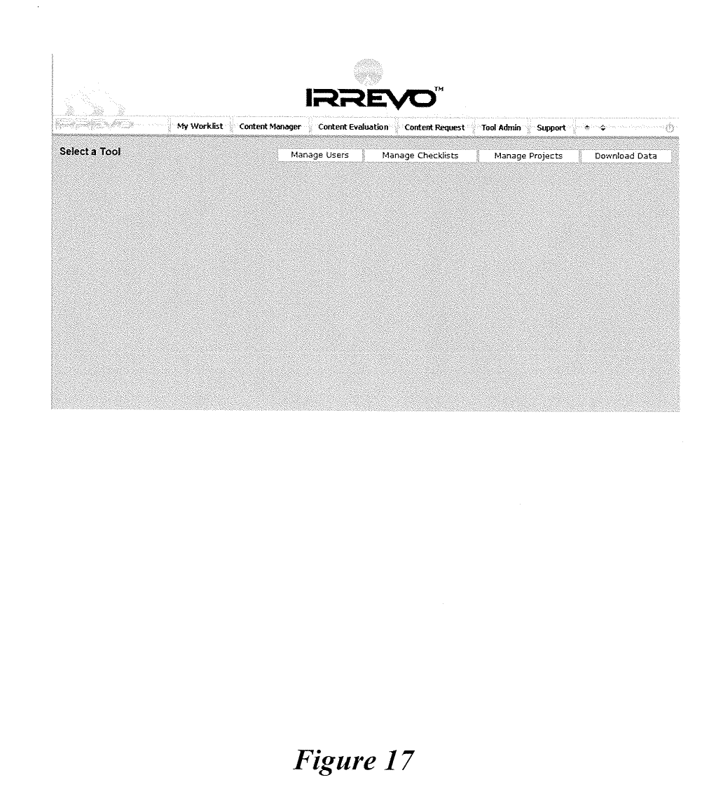

FIG. 17 is a screenshot of a Tool Administration page, in one embodiment. Within this section of the application users have the ability to manage the back-end functions of the application itself

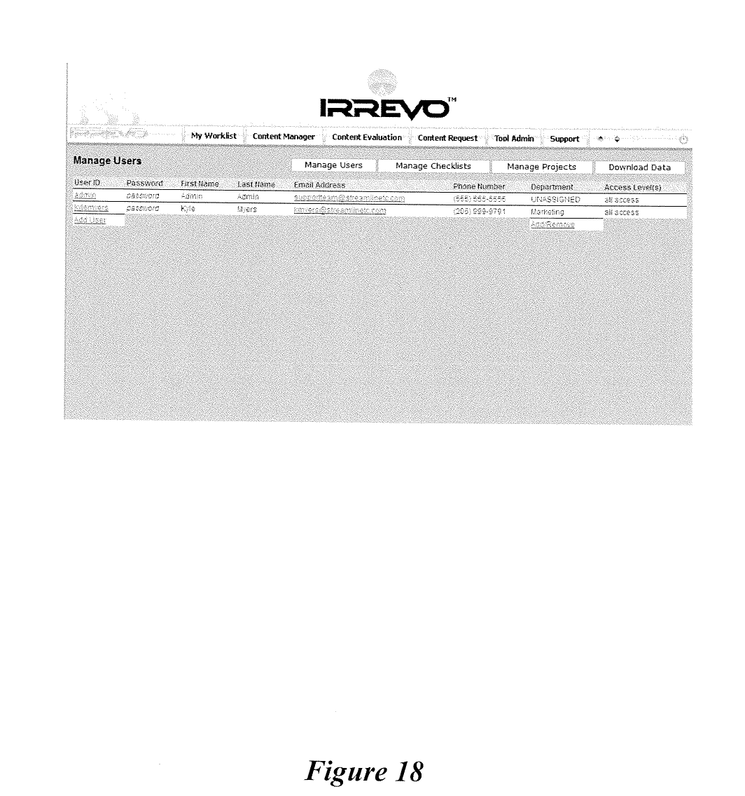

FIG. 18 is a screenshot of a Manage Users page, in one embodiment. Users access this section to Add, Modify, or Delete users and their departments.

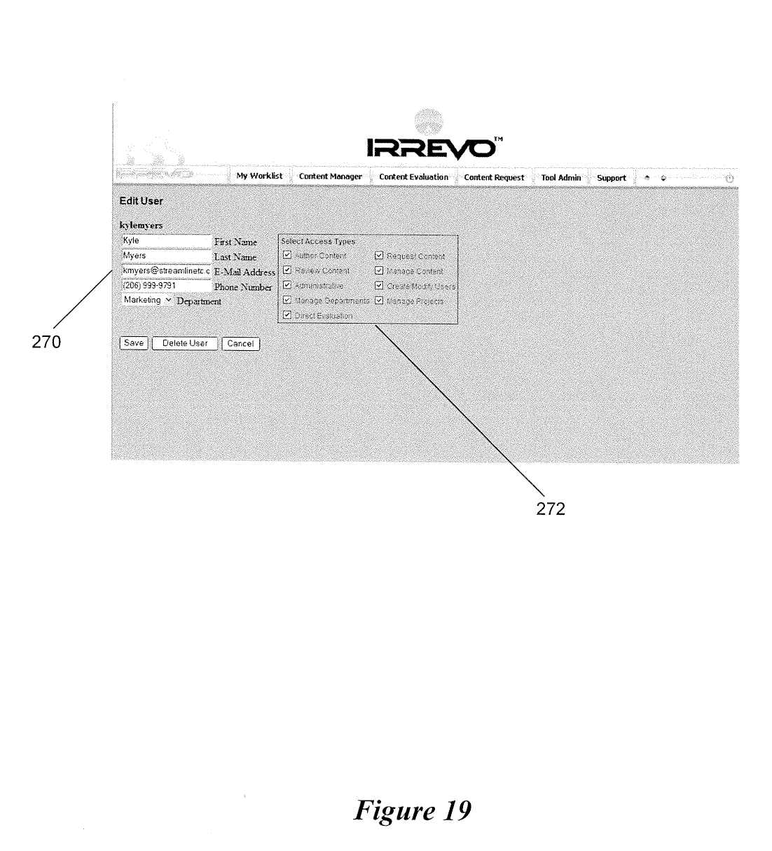

FIG. 19 is a screenshot of an Edit Users page, in one embodiment. Users access this section to enter in contact information into predefined textboxes 270, as well as to set access/security permissions for the other users in a series of checkboxes 272.

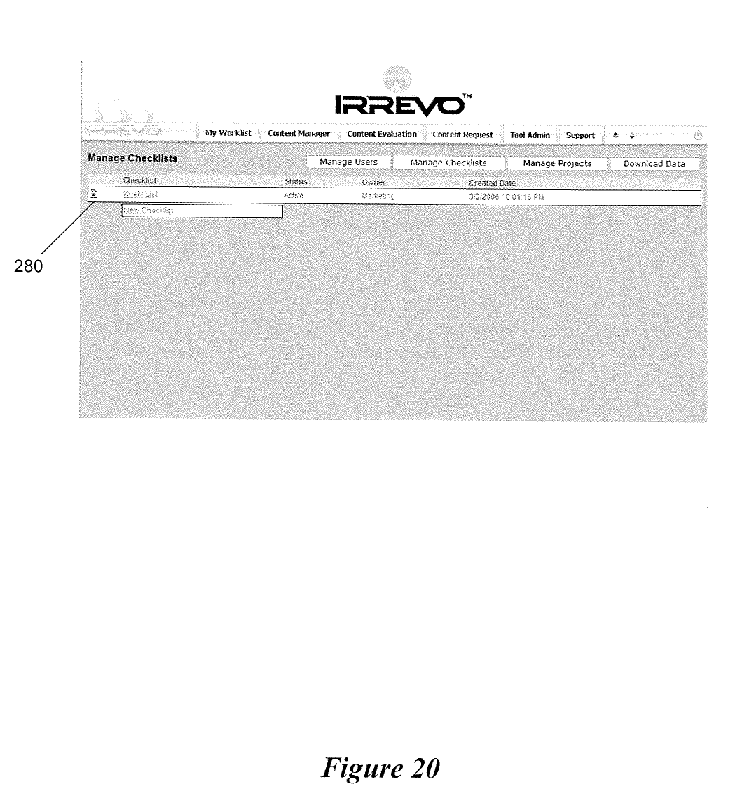

FIG. 20 is a screenshot of a Manage Checklists page, in one embodiment. Users may access existing checklists 280 or begin the process for creating a new checklist.

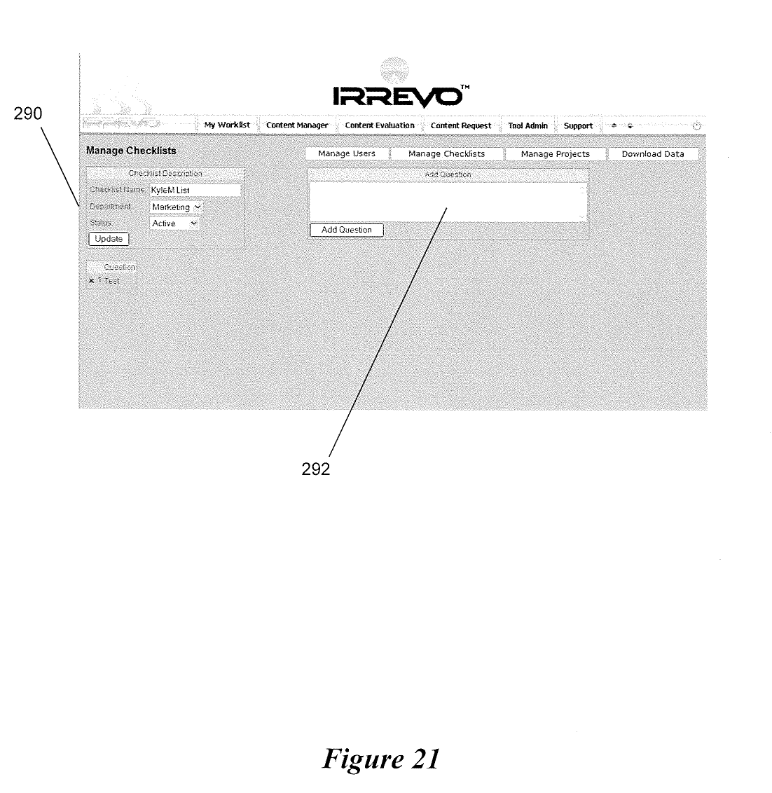

FIG. 21 is a screenshot of an Edit Checklists page. Users may access this section to manage the status of previous checklists, change the checklist name, associated department, and checklist status, as shown in box 290. Users may add or delete checklist items using this page. Also users may add a question in text box 292. In an alternate embodiment, a user may add the availability of an “N/A” checkbox for items that may not be applicable to the document being reviewed. Further in an alternate embodiment, a user is able to enter details surrounding the detailed standards behind the checklist entry. These detailed standards may be made visible to reviewers when applying the checklist.

FIG. 22 is a screenshot of a Manage Projects page, in one embodiment. A user may access this section to create new and/or edit existing review projects.

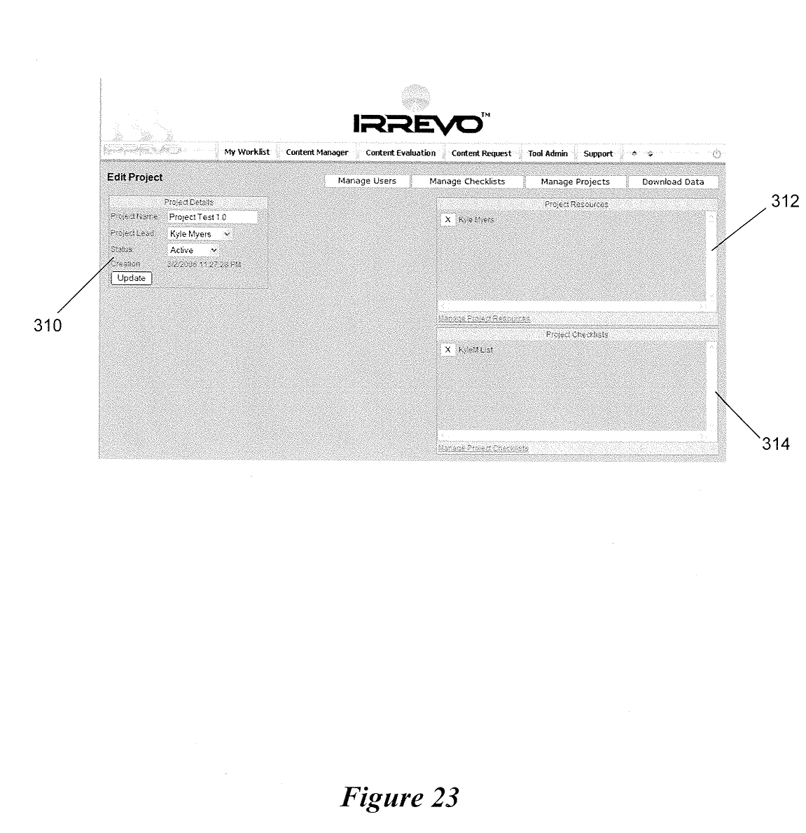

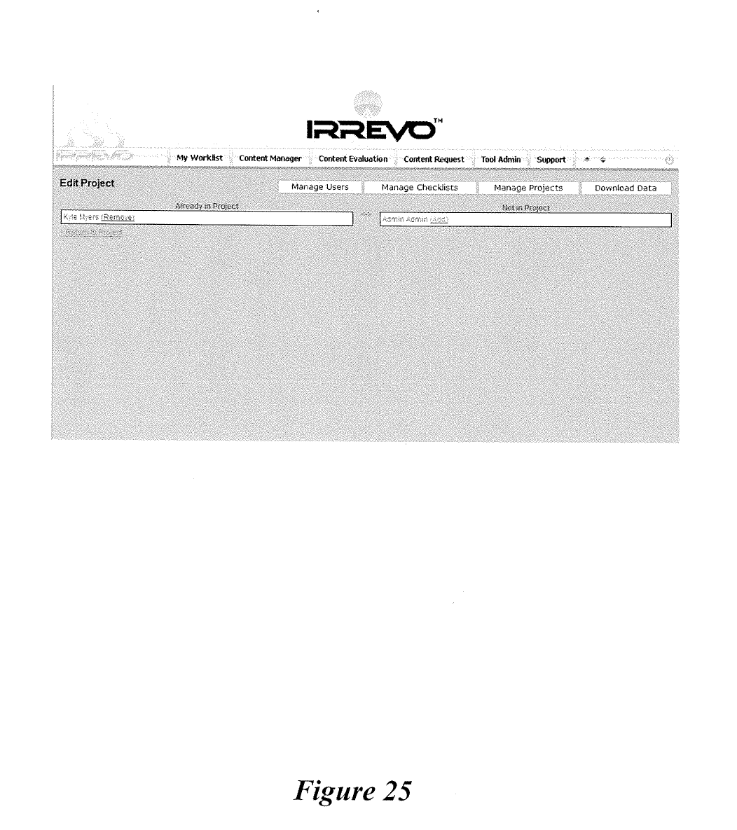

FIG. 23 is a screenshot of an Edit Projects page, in one embodiment. From this page, users have the functionality to change the project details 310, including status of a project being reviewed, change the project name, and/or change the project lead. A user also has access to the related project resources 312 and the Project checklists 314. A user may also elect to “Manage Checklists” (FIG. 20) or “Manage Resources” (FIG. 25) from this page.

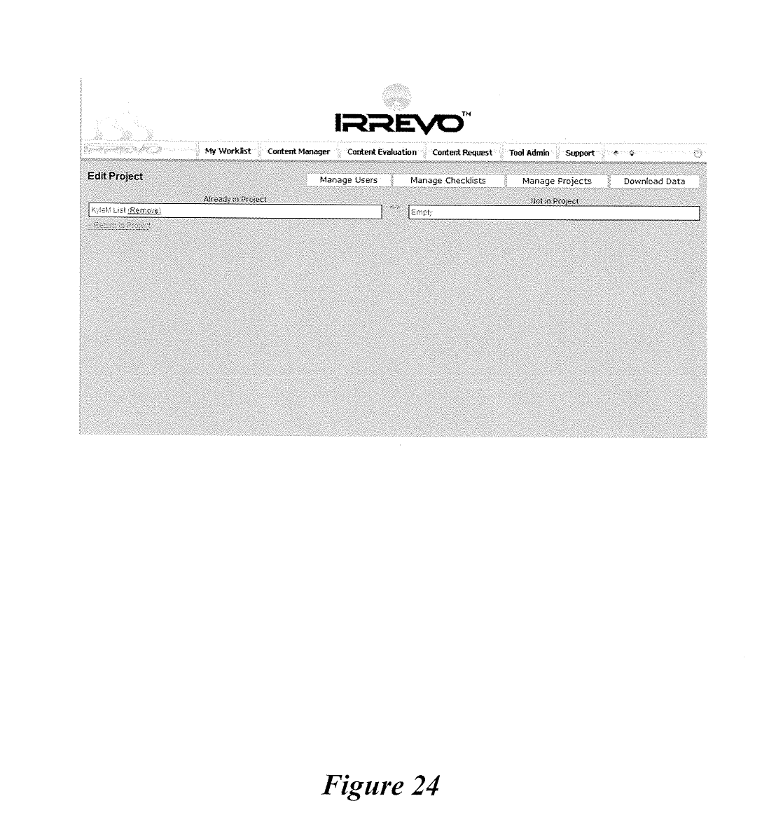

FIG. 24 is a screenshot of a Manage Checklists page, in one embodiment. When accessing this page, users may “Add” or “Remove” existing checklists from a review project. This page manages the checklists available on the “Select Checklist” (FIG. 10) page.

FIG. 25 is a screenshot of a Manage Resources page, in one embodiment. When accessing this page, users may “Add” or “Remove” existing users from a review project. This screen manages which users can view the checklists associated with the review project.

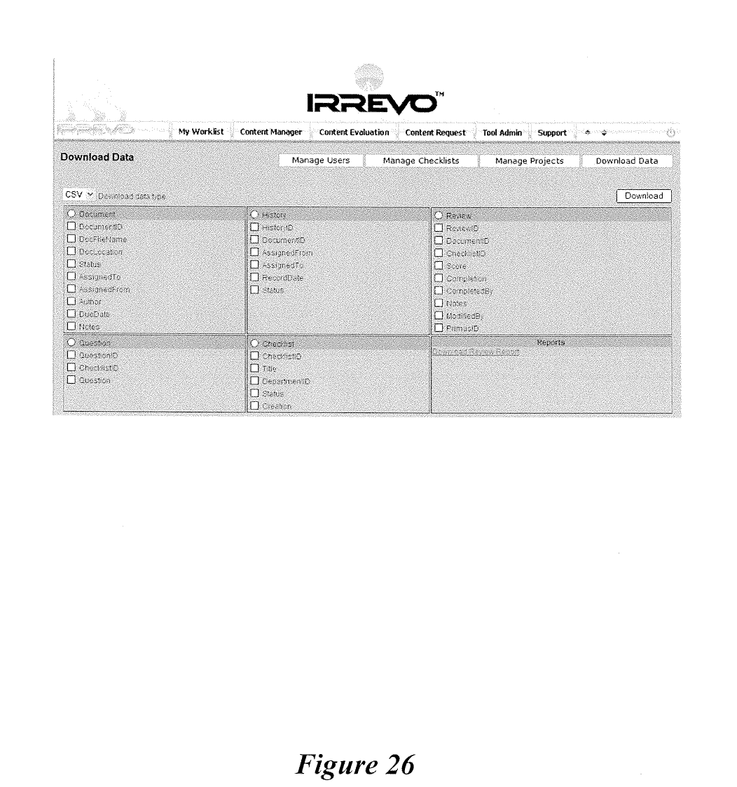

FIG. 26 is a screenshot of a Download Data page, in one embodiment. While in this page, users may select various fields for download from the application database to their computer. Users may also select to download a custom report or standard set of data values from various database tables.

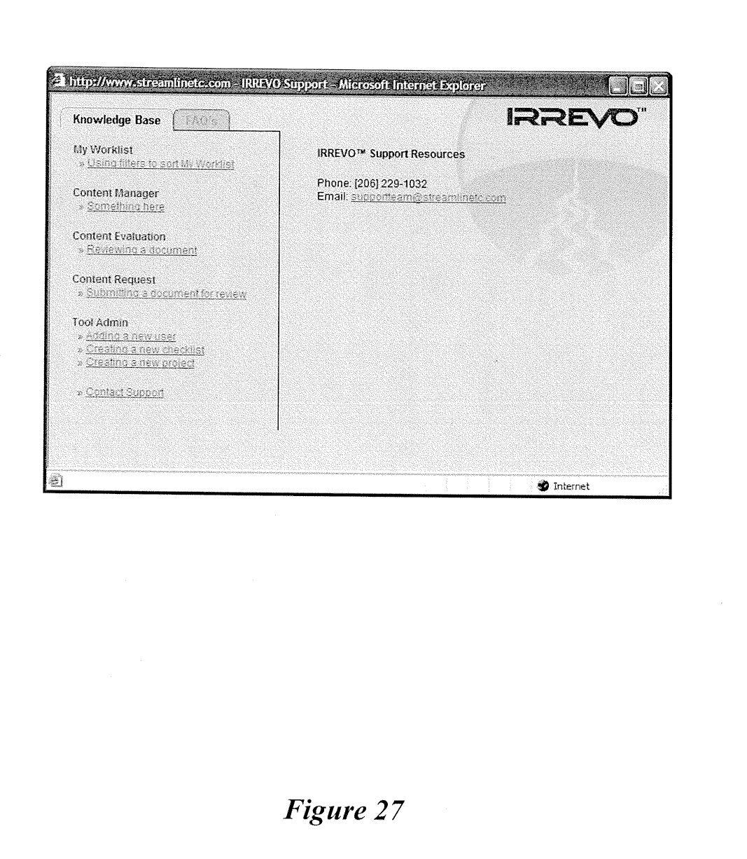

FIG. 27 is a screenshot of a Support Site Knowledge Base, in one embodiment. Users can access the “Support Site” to find answers to some general questions about the application. They can also find contact information for support services.

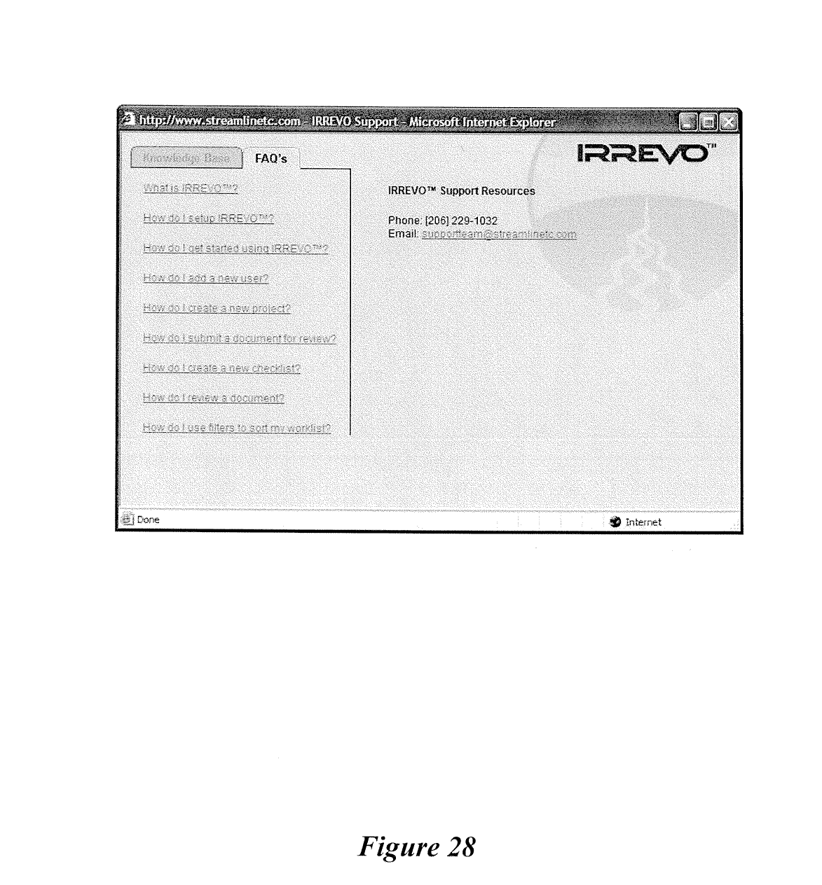

FIG. 28 is a screenshot of a Support Site FAQ's page, in one embodiment. While accessing the “Support Site” users may click the “Support Site FAQ's” tab to access answers to some of their most common questions.

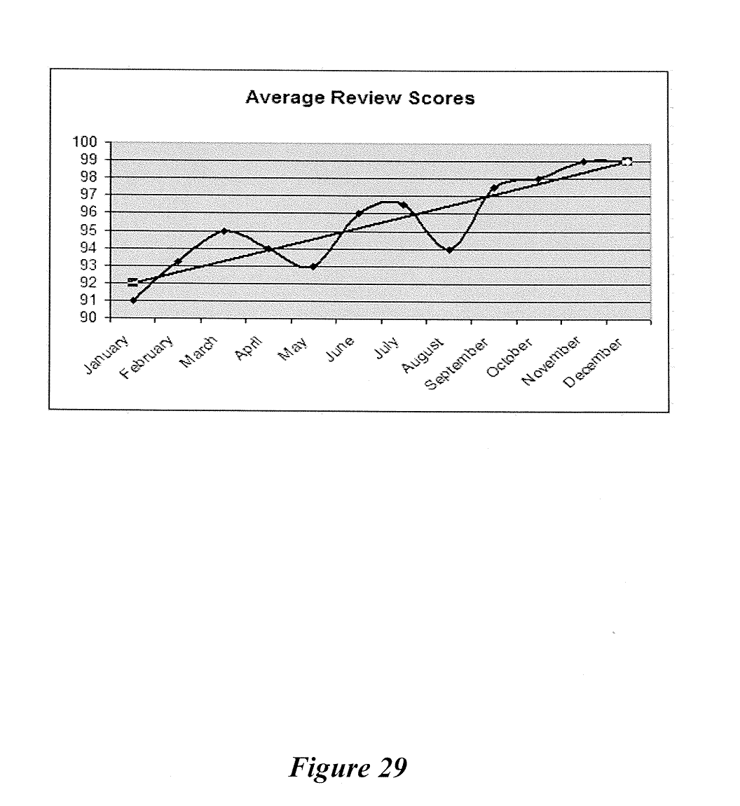

FIGS. 29-35 shows screenshots of example reports, in one embodiment. FIG. 29 is a screenshot of an Average Review Scores report. This report presents the averages of checklist items that “Passed” without findings each month.

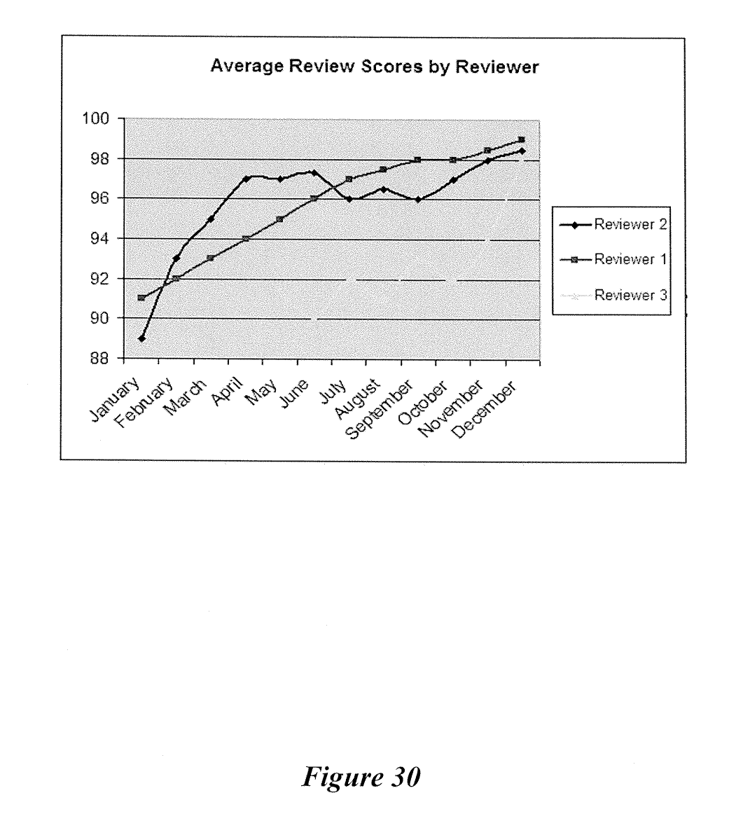

FIG. 30 is a screenshot of an Average Review Scores by Reviewer report. This report presents the averages of checklist items that “Passed” without findings for individual users by month. Users can also view the differences in these review scores to gauge reviewer calibration on the consistent and even application of the standards.

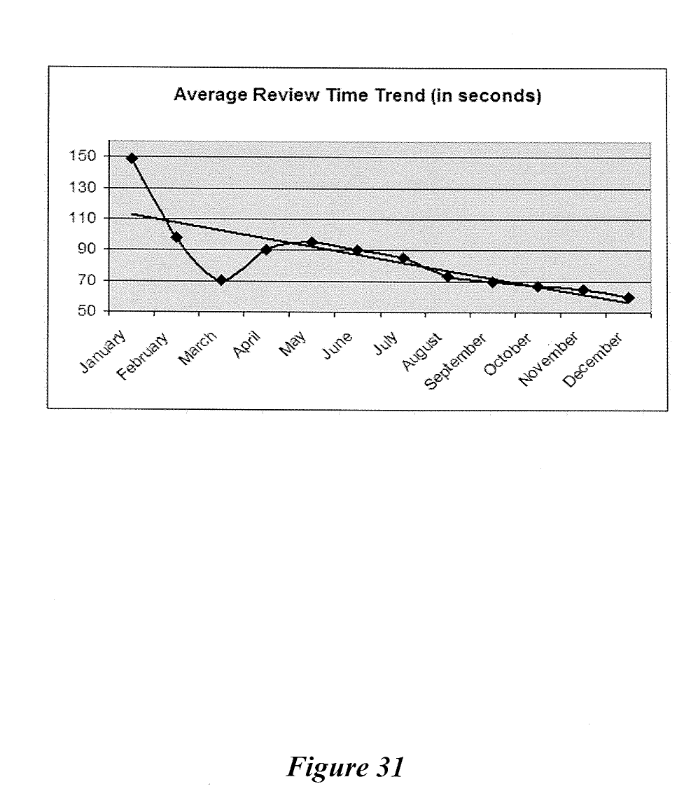

FIG. 31 is a screenshot of an Overall Average Review Time report. This report presents the average review times in seconds based on the “Checklist Timer” described in FIG. 13.

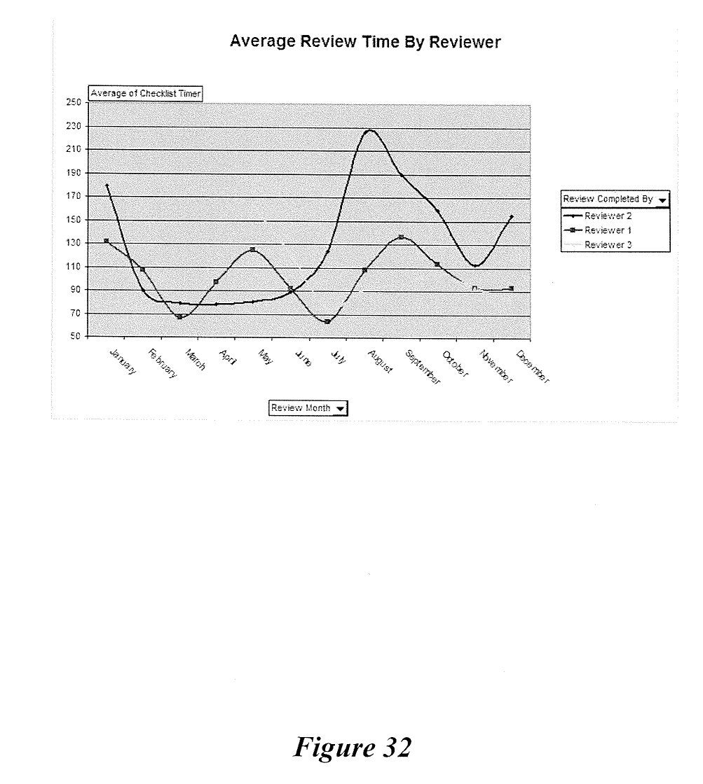

FIG. 32 is a screenshot of an Average Review Times by Reviewer report. This report presents the average amount of time each reviewer is taking to perform evaluations of the digital media each month. Users can also view the differences in these review times to gauge calibration on the amount of time it is taking reviewers to apply the standards.

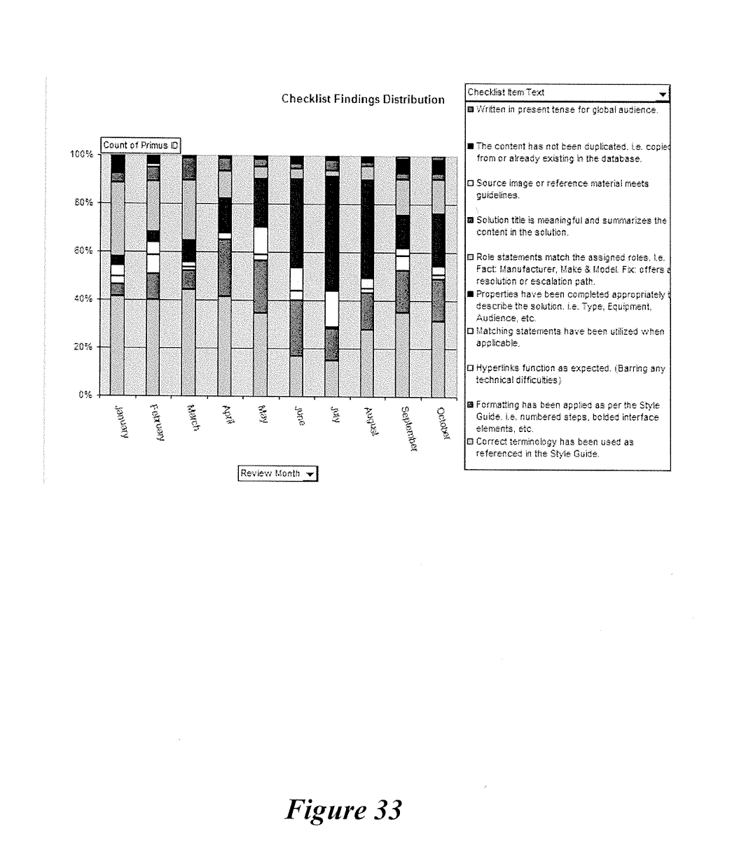

FIG. 33 is a screenshot of a Checklist Findings Distribution report. This report presents the user with the percent of total “Findings” for each checklist item by month. Users can also view the differences in the “Findings” between individual reviewers to gauge calibration on the consistent application of the standards.

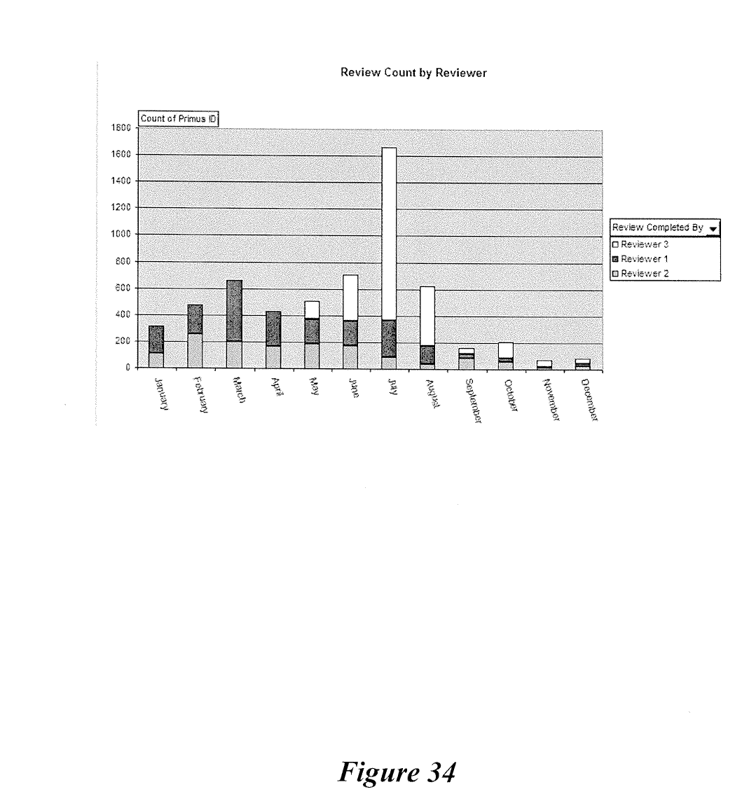

FIG. 34 is a screenshot of a Review Count by Reviewer report. This report presents the user with the total number of reviews performed by each individual reviewer by month.

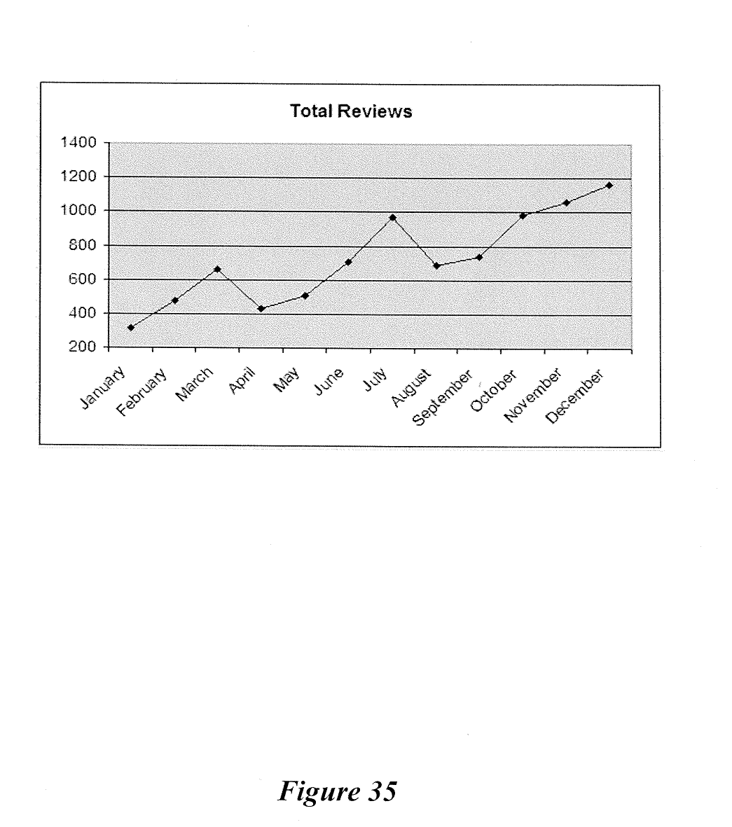

FIG. 35 is a screenshot of a Total Review Report. This report presents the user with the total number of reviews performed by all reviewers by month.

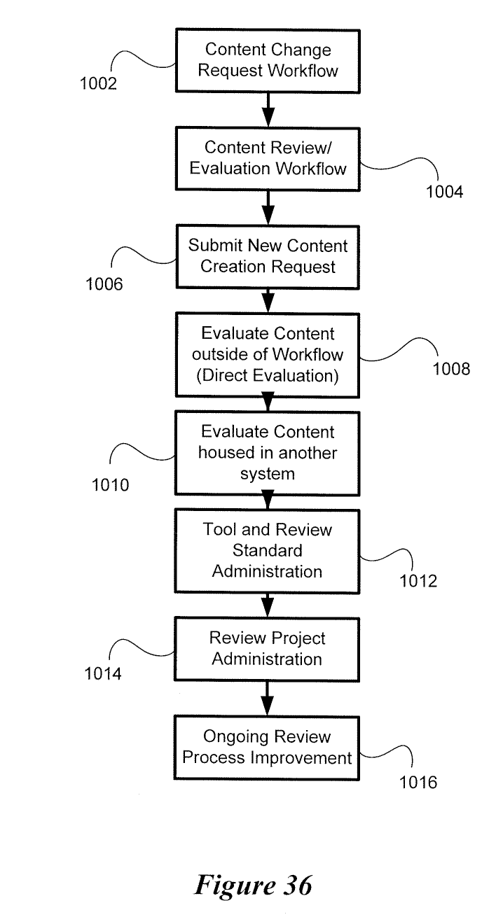

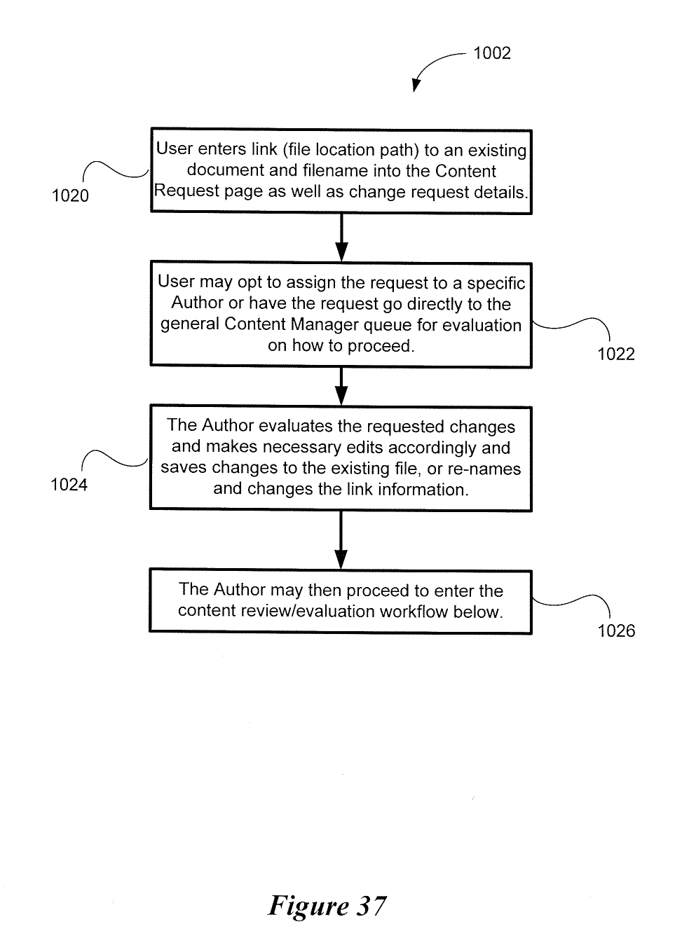

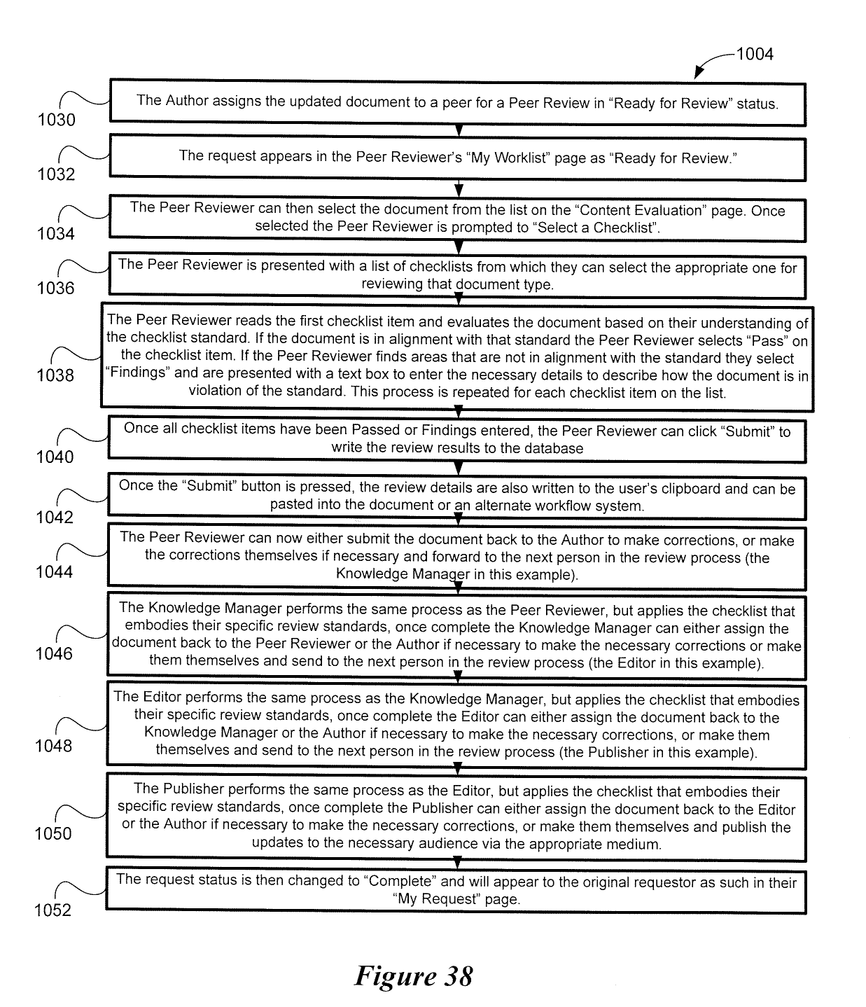

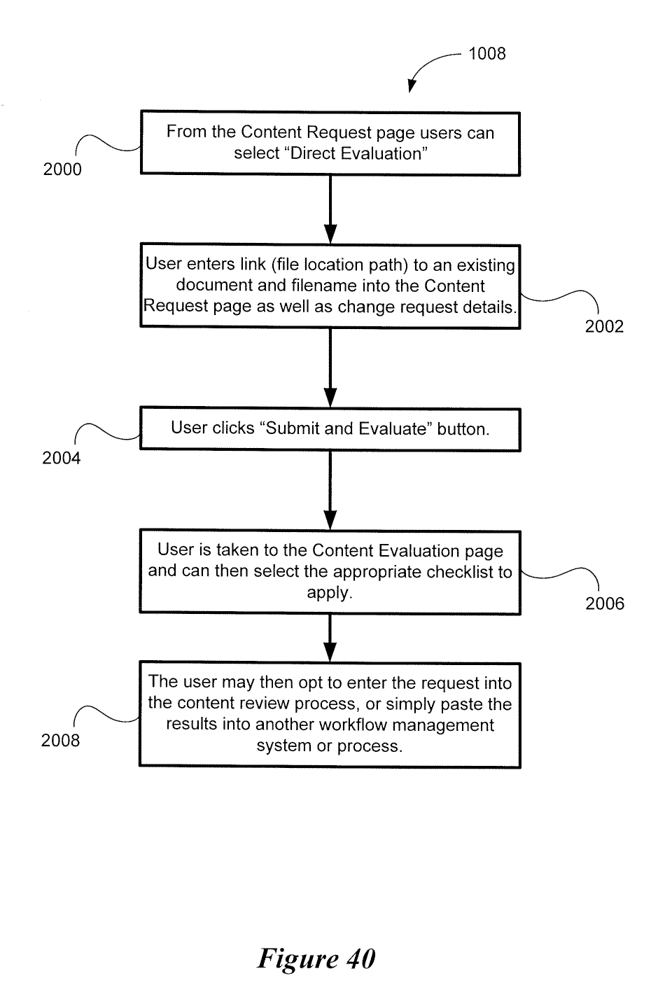

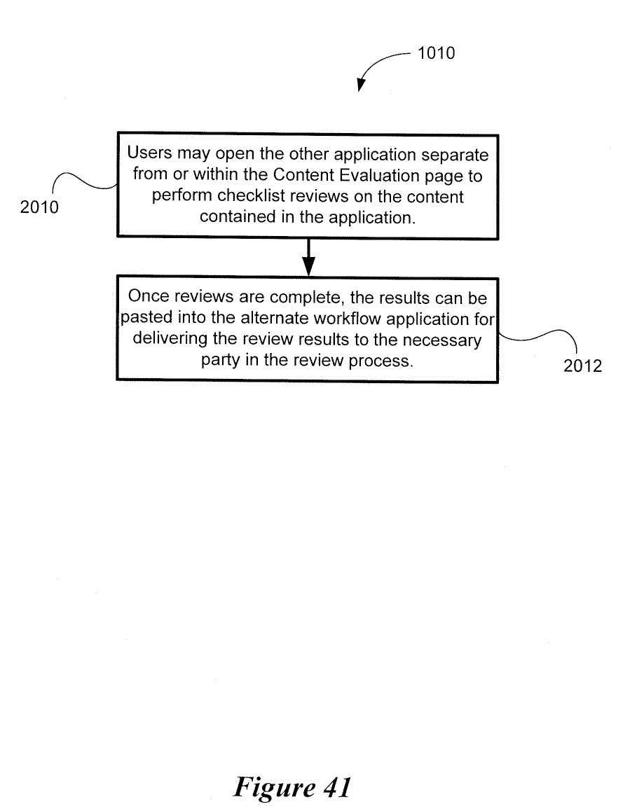

FIG. 36 represents a method for executing a preferred embodiment. The method begins at block 1002 with content change request workflow step, which is described in FIG. 37. At block 1004 there is content review/evaluation workflow step, which is further described in FIG. 38. At block 1006 there is a new content creation request step, which is further described in FIG. 40 At block 1008 there is a evaluate content outside of workflow (direct evaluation) step, which is further described in FIG. 41. At block 1010, there is a evaluate content housed in another system step. Users with administrative rights have access to the following pages in the “Tool Admin” section of the application: Manage Users; Manage Checklists; Manage Projects; and/or Download Data. At block 1012 there is a tool and review standard administration step, which is further described in FIG. 43. At block 1014 there is a review project administration step, which is further described in FIG. 44. Finally at block 1016 there is an ongoing review process improvement step. Content managers/administrators may analyze the data collected in a database (accessible via the Download Data page) to identify consistency in application of the set standards. From this analysis they may determine areas for training or coaching of teams and individuals for the purpose of making the review process more efficient.

FIG. 37 represents a method (1002) for content change request workflow. At block 1020, a user enters link (file location path) to an existing document and filename into the Content Request page as well as change request details. At block 1022, a user may opt to assign the request to a specific author or have the request go directly to the general Content Manager queue for evaluation on how to proceed. At block 1024, the Author evaluates the requested changes and makes necessary edits accordingly and saves changes to the existing file, or re-names and changes the link information. At block 1026, the Author may then proceed to enter the content review/evaluation workflow below.

FIG. 38 represents a method (1004) for content review/evaluation workflow. At block 1030, the Author assigns the updated document to a peer for a Peer Review in “Ready for Review” status. At block 1032, the request appears in the Peer Reviewer's “My Worklist” page as “Ready for Review.” At block 1034, the Peer Reviewer can then select the document from the list on the “Content Evaluation” page. Once selected the Peer Reviewer is prompted to “Select a Checklist”. At block 1036, the Peer Reviewer is presented with a list of checklists from which they can select the appropriate one for reviewing that document type. At block 1038, the Peer Reviewer reads the first checklist item and evaluates the document based on their understanding of the checklist standard. If the document is in alignment with that standard the Peer Reviewer selects “Pass” on the checklist item. If the Peer Reviewer finds areas that are not in alignment with the standard they select “Findings” and are presented with a text box to enter the necessary details to describe how the document is in violation of the standard. This process is repeated for each checklist item on the list. At block 1040, once all checklist items have been Passed or Findings entered, the Peer Reviewer can click “Submit” to write the review results to the database. The review details include: Review Date and Time; Duration of review based on checklist timer (checklist start through submission minus time paused); Author's name; Reviewer's name; Checklist Name; Document Link and filename; and/or Checklist findings and details. At block 1042, once the “Submit” button is pressed, the review details are also written to the user's clipboard and can be pasted into the document or an alternate workflow system. At block 1044, the Peer Reviewer can now either submit the document back to the Author to make corrections, or make the corrections themselves if necessary and forward to the next person in the review process (the Knowledge Manager in this example). At block 1046, the Knowledge Manager performs the same process as the Peer Reviewer, but applies the checklist that embodies their specific review standards, once complete the Knowledge Manager can either assign the document back to the Peer Reviewer or the Author if necessary to make the necessary corrections or make them themselves and send to the next person in the review process (the Editor in this example). At block 1048, the Editor performs the same process as the Knowledge Manager, but applies the checklist that embodies their specific review standards, once complete the Editor can either assign the document back to the Knowledge Manager or the Author if necessary to make the necessary corrections, or make them themselves and send to the next person in the review process (the Publisher in this example). At block 1050, the Publisher performs the same process as the Editor, but applies the checklist that embodies their specific review standards, once complete the Publisher can either assign the document back to the Editor or the Author if necessary to make the necessary corrections, or make them themselves and publish the updates to the necessary audience via the appropriate medium. At block 152, the request status is then changed to “Complete” and can appear to the original requestor as such in their “My Request” page.

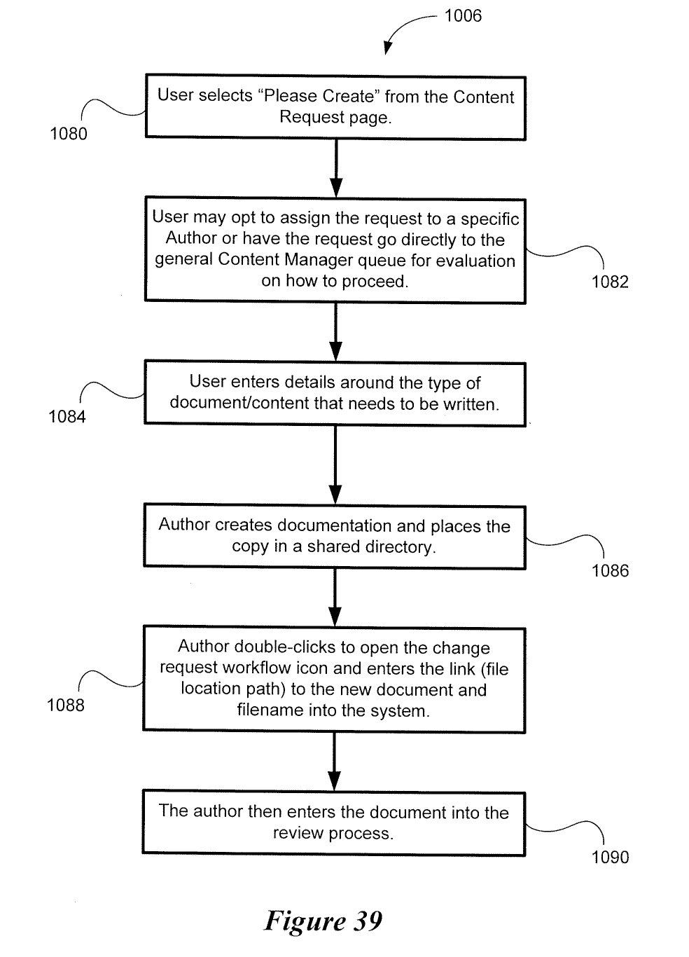

FIG. 39 represents a method (1006) for submitting a new content creation request. At block 1080 a user selects “Please Create” from the Content Request page. At block 1082, a user may opt to assign the request to a specific Author or have the request go directly to the general Content Manager queue for evaluation on how to proceed. At block 1084 a user enters details around the type of document/content that needs to be written. At block 1086, an author creates documentation and places the copy in a shared directory. At block 1088, an author double-clicks to open the change request workflow icon and enters the link (file location path) to the new document and filename into the system. At block 1090, the author then enters the document into the review process that begins in section 2.0.

FIG. 40 represents a method (1008) for evaluating content outside of workflow (direct evaluation). Users have the ability to bypass the workflow and evaluate a document immediately. At block 2000, a user can select “Direct Evaluation” from the Content Request page. At block 2002, a User enters link (file location path) to an existing document and filename into the Content Request page as well as change request details. At block 2004, a User clicks “Submit and Evaluate” button. At block 2006, a User is taken to the Content Evaluation page and can then select the appropriate checklist to apply. At block 2008, the user may then opt to enter the request into the content review process, or simply paste the results into another workflow management system or process.

FIG. 41 represents a method (1010) for evaluating content housed in another system step. A preferred embodiment can be utilized for reviewing and evaluating stand-alone documents or to review documents/content that resides in a web-application or content management system that has a workflow solution. At block 2010, a User may open the other application separate from or within the Content Evaluation page to perform checklist reviews on the content contained in the application. At block 2012, once reviews are complete, the results can be pasted into the alternate workflow application for delivering the review results to the necessary party in the review process.

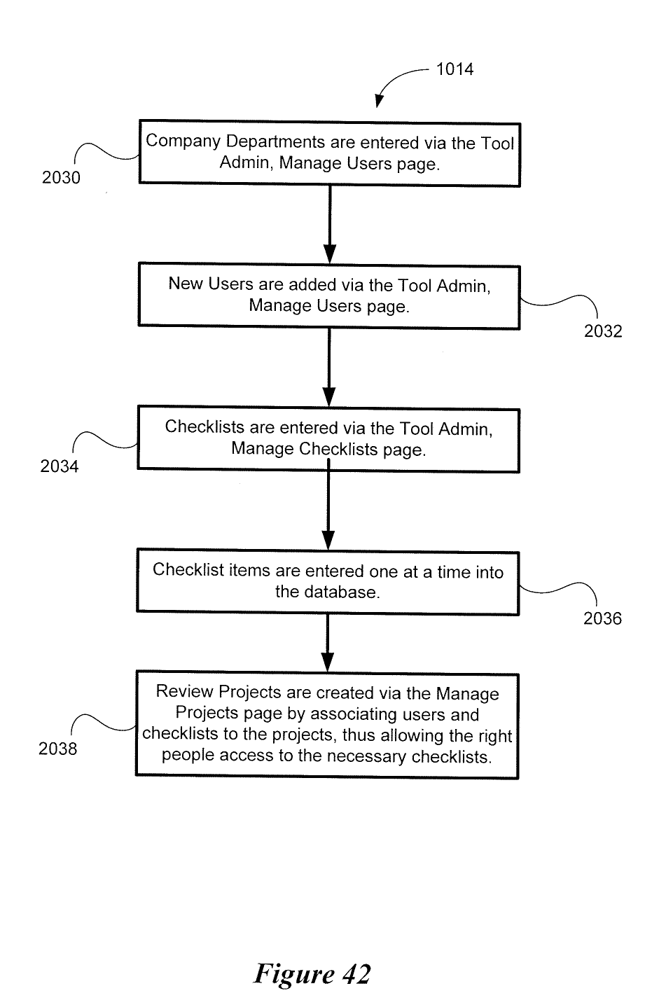

FIG. 42 represents a method (1014) for reviewing project administration. At block 2030, company departments are entered via the Tool Admin, Manage Users page. At block 2032, new Users are added via the Tool Admin, Manage Users page. At block 2034, Checklists are entered via the Tool Admin, Manage Checklists page. At block 2036, checklist items are entered one at a time into the database. At block 2038, review projects are created via the Manage Projects page by associating users and checklists to the projects, thus allowing the right people access to the necessary checklists.

While a preferred embodiment has been illustrated and described, as noted above, many changes can be made without departing from the spirit and scope of the preferred embodiment. For example, use in reviewing any chain of documents may be accomplished. Accordingly, the scope of a preferred embodiment is not limited by the disclosure of the preferred embodiment. Instead, a preferred embodiment should be determined entirely by reference to the claims that follow.

The embodiments of the invention in which an exclusive property or privilege is claimed are defined as follows:

1. A method for reviewing digital documents comprising:
receiving a digital document for review;
viewing a review checklist adjacent to the digital document for review;
evaluating the document against predefined review standards; and
entering at least one of a pass, a finding, and an not applicable on a checklist accompanying the document.

2. The method of claim 1 further comprising:
submitting a set of review findings to a relational database in order to track review trends.

3. The method of claim 1 further comprising:
accounting for review duration in accordance with the use of the review checklist.
